(19) United States
(12) Patent Application Publication
(10) Pub. No.: US 2004/0194280 A1
(43) Pub. Date: Oct. 7, 2004

(54) Rolling chassis and assembled bodies

(76) Inventors: Christopher E. Borroni-Bird, Oakland Township, MI (US); Adrian B. Chernoff, Royal Oak, MI (US); Mohsen D. Shabana, Ann Arbor, MI (US); Robert Louis Vitale, Macomb Township, MI (US); Tommy E. White, Rochester Hills, MI (US)

Correspondence Address: KATHRYN A MARRA, General Motors Corporation, Legal Staff, Mail Code 482-C23-B21, P.O. Box 300, Detroit, MI, 48265-3000, US

(21) Appl. No.: 10/408,841

(22) Filed: Apr. 7, 2003

(51) Int. Cl. B23P 11/00; B21D 39/03

(52) U.S. Cl. 29/469

(57) ABSTRACT

A method of assembling vehicles includes providing an X-by-wire chassis and mounting a vehicle body at an upper face of the chassis. The vehicle body includes a body frame, a seating apparatus and one or more body panels, and may include a floor. The vehicle body may include one or more preassembled body modules. The invention contemplates that the body may be operatively connected to the chassis when it is mounted at the upper face of the chassis so that one or more of the systems in the chassis that are responsive to non-mechanical control signals will respond to such signals.

### TECHNICAL FIELD

This invention relates to the assembly of vehicle chassis and bodies.

### BACKGROUND OF THE INVENTION

Mobility, being capable of moving from place to place or of moving quickly from one state to another, has been one of the ultimate goals of humanity throughout recorded history. The automobile has likely done more in helping individuals achieve that goal than any other development. Since its inception, societies around the globe have experienced rates of change in their manner of living that are directly related to the percentage of motor vehicle owners among the population.

Prior art automobiles and light trucks include a body, the function of which is to contain and protect passengers and their belongings. Bodies are connected to the numerous mechanical, electrical, and structural components that, in combination with a body, comprise a fully functional vehicle. The nature of the prior art connections between a vehicle body and vehicular componentry may result in certain inefficiencies in the design, manufacture, and use of vehicles. Three characteristics of prior art body connections that significantly contribute to these inefficiencies are the quantity of connections; the mechanical nature of many of the connections; and the locations of the connections on the body and on the componentry.

In the prior art, the connections between a body and componentry are numerous. Each connection involves at least one assembly step when a vehicle is assembled; it is therefore desirable to reduce the number of connections to increase assembly efficiency. The connections between a prior art body and prior art vehicular componentry include multiple load-bearing connectors to physically fasten the body to the other components, such as bolts and brackets; electrical connectors to transmit electrical energy to the body from electricity-generating components and to transmit data from sensors that monitor the status of the componentry; mechanical control linkages, such as the steering column, throttle cable, and transmission selector; and ductwork and hoses to convey fluids such as heated and cooled air from an HVAC unit to the body for the comfort of passengers.

Many of the connections in the prior art, particularly those connections that transmit control signals, are mechanical linkages. For example, to control the direction of the vehicle, a driver sends control signals to the steering system via a steering column. Mechanical linkages result in inefficiencies, in part, because different driver locations in different vehicles require different mechanical linkage dimensions and packaging. Thus, new or different bodies often cannot use “off-the-shelf” components and linkages. Componentry for one vehicle body configuration is typically not compatible for use with other vehicle body configurations. Furthermore, if a manufacturer changes the design of a body, a change in the design of the mechanical linkage and the component to which it is attached may be required. The change in design of the linkages and components requires modifications to the tooling that produces the linkages and components.

The location of the connections on prior art vehicle bodies and componentry also results in inefficiencies. In prior art body-on-frame architecture, connection locations on the body are often not exposed to an exterior face of the body, and are distant from corresponding connections on the componentry; therefore, long connectors such as wiring harnesses and cables must be routed throughout the body from componentry. The vehicle body of a fully-assembled prior art vehicle is intertwined with the componentry and the connection devices, rendering separation of the body from its componentry difficult and labor-intensive, if not impossible. The use of long connectors increases the number of assembly steps required to attach a vehicle to its componentry.

Furthermore, prior art vehicles typically have internal combustion engines that have a height that is a significant proportion of the overall vehicle height. Prior art vehicle bodies are therefore designed with an engine compartment that occupies about a third of the front (or sometimes the rear) of the body length. Compatibility between an engine and a vehicle body requires that the engine fit within the body's engine compartment without physical part interference. Moreover, compatibility between a prior art chassis with an internal combustion engine and a vehicle body requires that the body have an engine compartment located such that physical part interference is avoided. For example, a vehicle body with an engine compartment in the rear is not compatible with a chassis with an engine in the front.

A self-contained chassis has substantially all of the mechanical, electrical, and structural componentry necessary for a fully functional vehicle, including at least an energy conversion system, a suspension and wheels, a steering system, and a braking system. The chassis has a simplified, and preferably standardized, interface with connection components to which bodies of substantially varying design can be attached. The interface is at an exposed upper face of the chassis. X-by-wire technology is utilized to eliminate mechanical control linkages.

### SUMMARY OF THE INVENTION

The invention allows simplified assembly of vehicles as vehicle bodies may be mounted at the exposed upper face of the self-contained X-by-wire chassis. As connection components are exposed and unobstructed, manufacturing efficiency is increased by designing the assembly process across all body designs based upon mounting at the upper face. As body designs need only conform to the simple attachment interface of the chassis, assembly of vehicles with a plurality of body designs may be accomplished using the same process, thus eliminating the need to redesign or reconfigure expensive components.

The invention includes a method of assembling vehicles including providing a preassembled X-by-wire chassis. The invention further includes mounting a vehicle body at an upper face of the preassembled chassis.

The vehicle body includes at least one seating apparatus adapted to be operably connectable to the chassis, a body frame adapted to be operably connectable to the chassis, and a plurality of body panels adapted to be operably connectable to the body frame. The body may further include a floor adapted to be mountable to the chassis; alternatively the floor may already be integral to the chassis.

If the body does not include a floor, mounting the body at the upper face of the preassembled chassis includes operatively connecting at least one seating apparatus to the chassis, operatively connecting the body frame to the chassis, and operatively connecting body panels to the body frame. If the body includes a floor, mounting the body at the upper face of the preassembled chassis includes mounting the floor to the preassembled chassis, operatively connecting at least one seating apparatus to the floor, operatively connecting the body frame to the chassis, and operatively connecting body panels to the body frame.

In another aspect of the invention, the body is operatively connected to the chassis when the body is mounted at the upper face of the chassis so that at least one of the X-by-wire braking, steering and energy conversion systems responsive to non-mechanical controls signals included in the chassis will respond to respective control signals.

The simplified assembly process further facilitates the use of preassembled body modules. As all connections are accomplished at one face of the chassis, body modules adapted to connect to such face may be utilized. This permits preassembly and prepackaging of modules to be optimized. Under the invention, the body may be a preassembled body module in which the body frame and a seating apparatus are operatively connected to the floor and body panels are operatively connected to the body frame. The invention further contemplates other body module configurations including bodies formed from two or more preassembled body modules each having a floor portion at least partially forming a floor, a body frame portion at least partially forming the body frame and operatively connected to the floor portion and at least one body panel operatively connected to the body frame portion. In addition, the invention contemplates the use of body modules consisting of a body frame portion at least partially forming the body frame and at least one body panel operatively connected to the body frame portion.

The method further includes maintaining an inventory of a plurality of preassembled body module configurations, and selecting body modules from the inventory for mounting the desired configuration.

The method further includes providing substantially identical first and second preassembled X-by-wire chassis, mounting a first body at the upper face of the first chassis, mounting a second body at the upper face of the second chassis, wherein the bodies each have at least two preassembled body modules and wherein the configuration of at least one of the preassembled body modules of the first body is sufficiently different than at least one of the preassembled body modules of the second body, such that the first body is different than the second body.

The above objects, features, and advantages, and other objects features, and advantages, of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in perspective view of a vehicle rolling platform according to an embodiment of the present invention;

FIG. 2 is a top view schematic illustration of the vehicle rolling platform shown in FIG. 1;

FIG. 3 is a bottom view schematic illustration of the vehicle rolling platform shown in FIGS. 1 and 2;

FIG. 4 is a schematic illustration in side view of a vehicle body pod and rolling platform attachment scenario according to the present invention that is useful with the embodiments of FIGS. 1-3;

FIG. 5 is a schematic illustration of a vehicle body pod and rolling platform attachment scenario, wherein body pods of differing configurations are each attachable to identical rolling platforms;

FIG. 6 is a schematic illustration of a steering system for use with the rolling platform and body pod shown in FIG. 4;

FIG. 7 is a schematic illustration of an alternative steering system for use in the rolling platform and body pod of FIG. 4;

FIG. 8 is a schematic illustration of a braking system for use with the rolling platform and body pod of FIG. 4;

FIG. 9 is a schematic illustration of an alternative braking system for use with the rolling platform and body pod of FIG. 4;

FIG. 10 is a schematic illustration of an energy conversion system for use with the rolling platform and body pod of FIG. 4;

FIG. 11 is a schematic illustration of an alternative energy conversion system for use with the rolling platform and body pod of FIG. 4;

FIG. 12 is a schematic illustration of a suspension system for use with the rolling platform of FIGS. 1-5;

FIG. 13 is a schematic illustration of an alternative suspension system for use with the rolling platform and body pod of FIG. 4;

FIG. 14 is a schematic illustration of a chassis computer and chassis sensors for use with the rolling platform and body pod of FIG. 4;

FIG. 15 is a schematic illustration of a master control unit with a suspension system, braking system, steering system, and energy conversion system for use with the rolling platform and body pod of FIG. 4;

FIG. 16 is a perspective illustration of a skinned rolling platform according to a further embodiment of the present invention;

FIG. 17 is a perspective illustration of a skinned rolling platform according to another embodiment of the present invention;

FIG. 18 is a side schematic illustration of a rolling platform with an energy conversion system including an internal combustion engine, and gasoline tanks;

FIG. 19 is a side schematic illustration of a rolling platform according to another embodiment of the invention, with a mechanical steering linkage and passenger seating attachment couplings;

FIGS. 20 and 20a show partial exploded perspective schematic illustrations of a rolling platform according to a further embodiment of the invention in an attachment scenario with a body pod, the rolling platform having multiple electrical connectors engageable with complementary electrical connectors in the body pod;

FIG. 21 is a perspective schematic illustration of a skinned rolling platform according to yet another embodiment of the invention, the rolling platform having a movable control input device;

FIG. 22 is a perspective schematic illustration of a rolling platform and vehicle body parts prior to assembly;

FIG. 23 is a perspective schematic illustration of a rolling platform and a preassembled body module prior to assembly;

FIG. 24 is a perspective schematic illustration of a rolling platform and two preassembled body modules each including a floor portion prior to assembly;

FIG. 25 is a perspective schematic illustration of a rolling platform, two preassembled body modules, a seat, and a floor prior to assembly;

FIG. 26 is a perspective schematic illustration of a rolling platform, two preassembled body modules and two floor portions prior to assembly;

FIG. 27 is a flow diagram illustrating a method of assembling a vehicle including mounting a vehicle body at an upper face of a preassembled chassis in accordance with the invention;

FIG. 28 is a perspective schematic illustration of a method of assembling a vehicle including positioning the chassis below the body prior to mounting the body at the upper face of the chassis in accordance with the invention;

FIG. 29 is a perspective schematic illustration of a method of assembling a vehicle including positioning the body above the chassis prior to mounting the body at the upper face of the chassis in accordance with the invention;

FIG. 30 is a flow diagram illustrating mounting a vehicle body at an upper face of a preassembled X-by-wire chassis in accordance with the invention; and

FIG. 31 is a flow diagram illustrating a method of assembling vehicles using differently configured body modules in accordance with the invention.

### DETAILED DESCRIPTION OF THE PREFERRED EMBODIMENT

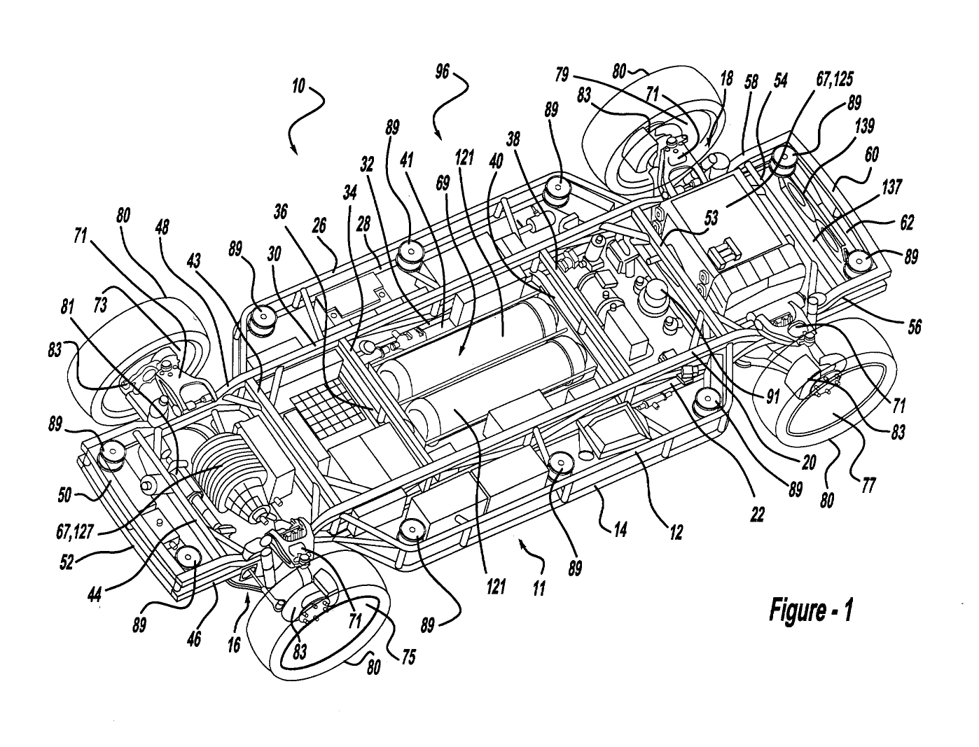

Referring to FIG. 1, a vehicle chassis 10 in accordance with the invention, also referred to as a “rolling platform,” includes a structural frame 11. The structural frame 11 depicted in FIG. 1 comprises a series of interconnected structural elements including upper and lower side structural elements 12 and 14 that comprise a “sandwich”-like construction. Elements 12 and 14 are substantially rigid tubular (or optionally solid), members that extend longitudinally between the front and rear axle areas 16, 18, and are positioned outboard relative to similar elements 20, 22. The front and rear ends of elements 12, 14 are angled inboard, extending toward elements 20 and 22 and connecting therewith prior to entering the axle areas 16, 18. For added strength and rigidity a number of vertical and angled structural elements extend between elements 12, 14, 20 and 22. Similar to the elements 12, 14, 20 and 22, which extend along the left side of the rolling platform 10, a family of structural elements 26, 28, 30 and 32 extend along the right side thereof.

Lateral structural elements 34, 36 extend between elements 20, 30 and 22, 32, respectively nearer the front axle area 16 and lateral structural elements 38, 40 extend between elements 20, 30 and 22, 32, respectively nearer the rear axle area 18, thereby defining a mid-chassis space 41. The front axle area 16 is defined in and around structural elements 43, 44 at the rear and front, and on the sides by structural elements 46, 48 which may be extensions of the elements 20, 22, 30, 32 or connected therewith. Forward of the front axle area, a forward space is defined between element 44 and elements 50, 52. The rear axle area 18 is defined in and around structural elements 53, 54 at the front and rear, and on the sides by structural elements 56, 58, which may be extensions of the elements 20, 22, 30, 32 or connected therewith. Rearward of the rear axle area 18, a rearward space is defined between element 54 and elements 60, 62. Alternatively, the rear axle area 18 or the rearward space may be elevated relative to the rest of the structural frame 11 if necessary to accommodate an energy conversion system, and the frame may include other elements to surround and protect an energy conversion system. The frame defines a plurality of open spaces or cavities between the elements described above. Those skilled in the art will recognize materials and fastening methods suitable for use in the structural frame. For example, the structural elements may be tubular, aluminum, and welded at their respective connections to other structural elements.

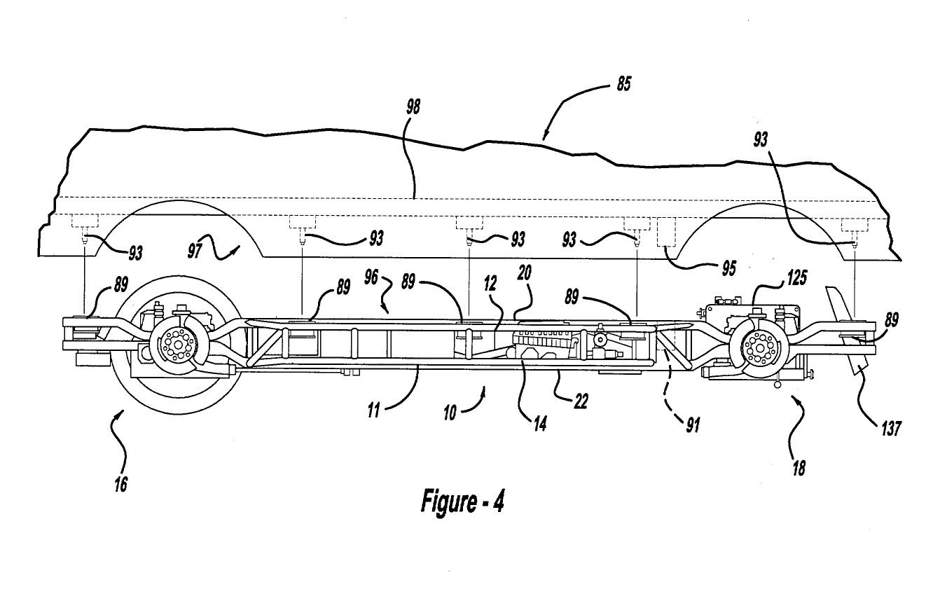

The structural frame 11 provides a rigid structure to which an energy conversion system 67, energy storage system 69, suspension system 71 with wheels 73, 75, 77, 79 (each wheel having a tire 80), steering system 81, and braking system 83 are mounted, as shown in FIGS. 1-3, and is configured to support an attached body 85, as shown in FIG. 4. A person of ordinary skill in the art will recognize that the structural frame 11 can take many different forms, in addition to the cage-like structure of the embodiment depicted in FIGS. 1-3. For example, the structural frame 11 can be a traditional automotive frame having two or more longitudinal structural members spaced a distance apart from each other, with two or more transverse structural members spaced apart from each other and attached to both longitudinal structural members at their ends. Alternatively, the structural frame may also be in the form of a “belly pan,” wherein integrated rails and cross members are formed in sheets of metal or other suitable material, with other formations to accommodate various system components. The structural frame may also be integrated with various chassis components.

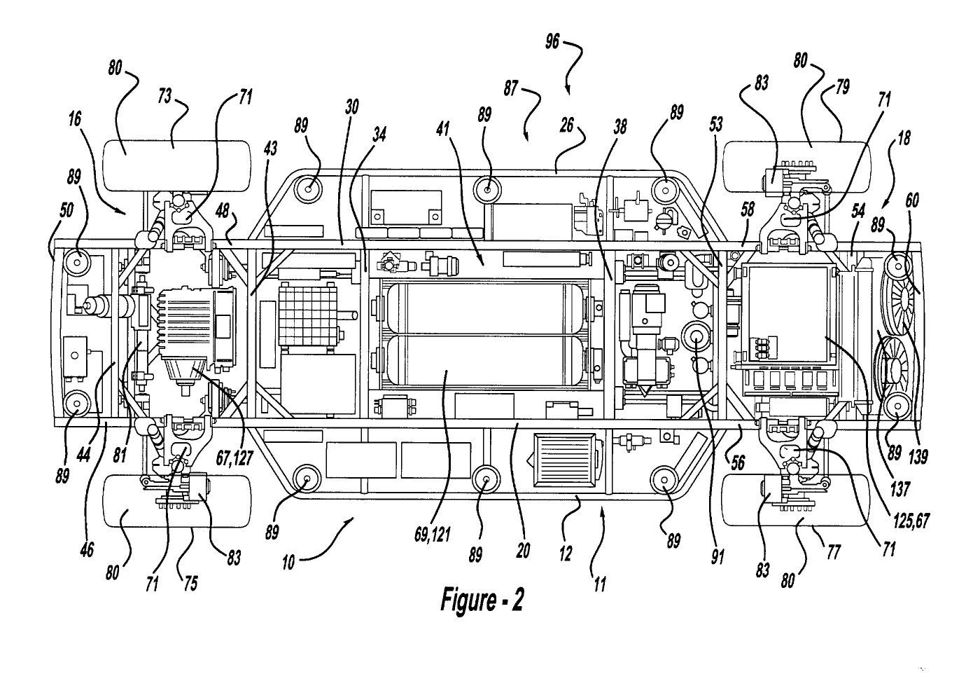

Referring to FIG. 2, a body attachment interface 87 is defined as the sum of all body connection components, i.e., connective elements that function to operably mate a vehicle body to the chassis 10. The body connection components of the preferred embodiment include a plurality of load-bearing body-retention couplings 89 mounted with respect to the structural frame 11 and a single electrical connector 91.

As shown in FIG. 4, the load-bearing body-retention couplings 89 are engageable with complementary attachment couplings 93 on a vehicle body 85 and function to physically fasten the vehicle body 85 to the chassis 10. Those skilled in the art will recognize that a multitude of fastening and locking elements may be used and fall within the scope of the claimed invention. The load-bearing body-retention couplings 89 are preferably releasably engageable with complementary couplings, though non-releasably engageable couplings such as weld flanges or riveting surfaces may be employed within the scope of the claimed invention. Ancillary fastening elements may be used as lock downs in conjunction with the load-bearing body-retention couplings. Load-bearing surfaces without locking or fastening features on the chassis 10 may be used with the load-bearing body-retention couplings 89 to support the weight of an attached vehicle body 85. In the preferred embodiment, the load-bearing body-retention couplings 89 include support brackets with bolt holes. Rubber mounts (not shown) located on the support brackets dampen vibrations transmitted between the body and the chassis. Alternatively, hard mounts may be employed for body-retention couplings.

The electrical connector 91 is engageable with a complementary electrical connector 95 on a vehicle body 85. The electrical connector 91 of the preferred embodiment may perform multiple functions, or select combinations thereof. First, the electrical connector 91 may function as an electrical power connector, i.e., it may be configured to transfer electrical energy generated by components on the chassis 10 to a vehicle body 85 or other non-chassis destination. Second, the electrical connector 91 may function as a control signal receiver, i.e., a device configured to transfer non-mechanical control signals from a non-chassis source to controlled systems including the energy conversion system, steering system, and braking system. Third, the electrical connector 91 may function as a feedback signal conduit through which feedback signals are made available to a vehicle driver. Fourth, the electrical connector 91 may function as an external programming interface through which software containing algorithms and data may be transmitted for use by controlled systems. Fifth, the electrical connector may function as an information conduit through which sensor information and other information is made available to a vehicle driver. The electrical connector 91 may thus function as a communications and power “umbilical” port through which all communications between the chassis 10 and an attached vehicle body 85 are transmitted. Electrical connectors include devices configured to operably connect one or more electrical wires with other electrical wires. The wires may be spaced a distance apart to avoid any one wire causing signal interference in another wire operably connected to an electrical connector or for any reason that wires in close proximity may not be desirable.

If one electrical connector performing multiple functions is not desirable, for example, if a cumbersome wire bundle is required, or power transmission results in control signal interference, the body attachment interface 87 may include a plurality of electrical connectors 91 engageable with a plurality of complementary electrical connectors 95 on a vehicle body 85, with different connectors performing different functions. A complementary electrical connector 95 performs functions complementary to the function of the electrical connector with which it engages, for example, functioning as a control signal transmitter when engaged with a control signal receiver.

Referring again to FIGS. 1-3, the energy conversion system 67, energy storage system 69, steering system 81, and braking system 83, are configured and positioned on the chassis 10 to minimize the overall vertical height of the chassis 10 and to maintain a substantially horizontal upper chassis face 96. A face of an object is an imaginary surface that follows the contours of the object that face, and are directly exposed to, a particular direction. Thus, the upper chassis face 96 is an imaginary surface that follows the upwardly facing and exposed contours of the chassis frame 11 and systems mounted therein. Matable vehicle bodies have a corresponding lower body face 97 that is an imaginary surface that follows the downwardly facing and exposed contours of the body 85, as shown in FIG. 4.

Referring again to FIGS. 1-3, the structural frame 11 has a thickness defined as the vertical distance between its highest point (the top of structural element 20) and its lowest point (the bottom of structural element 22). In the preferred embodiment, the structural frame thickness is approximately 11 inches. To achieve a substantially horizontal upper chassis face 96, the energy conversion system 67, energy storage system 69, steering system 81, and braking system 83 are distributed throughout the open spaces and are configured, positioned, and mounted to the structural frame 11 such that the highest point of any of the energy conversion system 67, energy storage system 69, steering system 81, and braking system 83 does not extend or protrude higher than the highest point of the structural frame 11 by an amount more than 50% of the structural frame thickness. Alternatively, the highest point of any of the energy conversion system 67, energy storage system 69, steering system 81, and braking system 83 does not extend or protrude higher than the top of any of the tires 80. Alternatively, the highest point of any of the energy conversion system 67, energy storage system 69, steering system 81, and braking system 83 does not extend or protrude higher than the top of any of the wheels 73, 75, 77, 79. In the context of the present invention, a tire is not considered part of a wheel. A wheel typically comprises a rim and a wheel disc or nave that connects the rim to a wheel hub, and does not include a mounted tire. A tire is mounted around the periphery of a wheel. The substantially horizontal upper chassis face 96 enables the attached vehicle body 85 to have a passenger area that extends the length of the chassis, unlike prior art bodies that have an engine compartment to accommodate a vertically-protruding internal combustion engine.

Most of the powertrain load is evenly distributed between the front and rear of the chassis so there is a lower center of gravity for the whole vehicle without sacrificing ground clearance, thereby enabling improved handling while resisting rollover forces.

Referring again to FIG. 4, the preferred embodiment of the rolling platform 10 is configured such that the lower body face 97 of a matable vehicle body 85 is positioned closely adjacent to the upper chassis face 96 for engagement with the rolling platform 10. The body connection components have a predetermined spatial relationship relative to one another, and are sufficiently positioned, exposed, and unobstructed such that when a vehicle body 85 having complementary connection components (complementary attachment couplings 93 and a complementary electrical connector 95) in the same predetermined spatial relationship as the body connection components is sufficiently positioned relative to the upper chassis face 96 of a chassis 10 of the invention, the complementary connection components are adjacent to corresponding body connection components and ready for engagement, as depicted in FIG. 4. In the context of the present invention, a body connection component having a protective covering is exposed and unobstructed if the protective covering is removable or retractable.

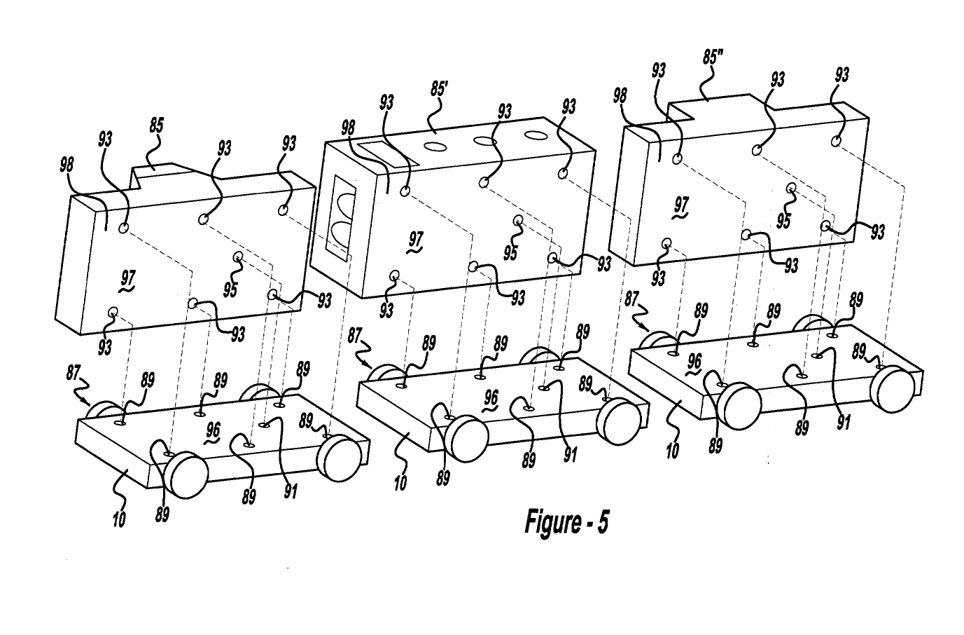

Each body connection component has a spatial relationship relative to each of the other body connection components that can be expressed, for example, as a vector quantity. Body connection components and complementary connection components have the same predetermined spatial relationship if the vector quantities that describe the spatial relationship between a body connection component and the other body connection components to be engaged also describe the spatial relationship between a corresponding complementary connection component and the other complementary connection components to be engaged. For example, the spatial relationship may be defined as follows: a first body connection component is spaced a distance Ax+By from a reference point; a second body connection component is spaced a distance Cx+Dy from the reference point; a third body connection component is spaced a distance Ex+Fy from the reference point, etc. Corresponding complementary connection components in the same predetermined spatial relationship are spaced in a mirror image relationship in the lower body face, as depicted in FIGS. 4 and 5. A protective covering (not shown) may be employed to protect any of the body connection components.

The body connection components and the complementary connection components are preferably adjacent without positional modification when a vehicle body 85 is sufficiently positioned relative to a chassis 10 of the invention; however, in the context of the present invention, the body connection components may be movable relative to each other within a predetermined spatial relationship to accommodate build tolerances or other assembly issues. For example, an electrical connector may be positioned and operably connected to a signal-carrying cable. The cable may be fixed relative to the structural frame at a point six inches from the electrical connector. The electrical connector will thus be movable within six inches of the fixed point on the cable. A body connection component is considered adjacent to a complementary connection component if one or both are movable within a predetermined spatial relationship so as to be in contact with each other.

Referring to FIG. 5, the body-attachment interface of the claimed invention enables compatibility between the chassis 10 and different types of bodies 85, 85′, 85″ having substantially different designs. Bodies 85, 85′, 85″ having a common base 98 with complementary attachment couplings 93 and complementary electrical connectors 95 in the same predetermined spatial relationship with one another as the predetermined spatial relationship between body connection components on the body-attachment interface 87, are each matable with the chassis 10 by positioning the body 85, 85′, 85″ relative to the chassis 10 such that each complementary attachment coupling 93 is adjacent to a load-bearing body-retention coupling 89, and the complementary electrical connector 95 is adjacent to the electrical connector 91. Preferably, all bodies and chassis comply with this common, standardized interface system, thereby facilitating compatibility between a wide array of different body types and styles and a single chassis design. The substantially horizontal upper chassis face 96 also facilitates compatibility between the rolling platform 10 and a multitude of differently-configured body styles. The common base 98 functions as a body structural unit and forms the lower body face 97 in the embodiment depicted. FIG. 5 schematically depicts a sedan 85, a van 85′, and a pickup truck 85″ each having a common base 98.

The body connection components are preferably sufficiently exposed at a chassis face to facilitate attachment to complementary connection components on a matable vehicle body. Similarly, complementary connection components on a matable vehicle body are sufficiently exposed at a body face to facilitate attachment to body connection components on a vehicle chassis. The body connection components are preferably located at or above the upper chassis face for engagement with complementary connection components located at or below a lower body face.

A connection device may be employed to engage or operably connect a body connection component with a distant complementary connection component, in the situation where a vehicle body does not have complementary connection components in the same predetermined spatial relationship as the body connection components on a vehicle chassis. For example, a cable having two connectors, one connector engageable with the electrical connector on a body attachment interface and the other connector engageable with a complementary connector on a matable vehicle body, may be used to operably connect the electrical connector and the complementary connector.

The bodies 85, 85′, 85″ shown schematically in FIG. 5 each use all of the body connection components on the vehicle chassis 10. However, within the scope of the claimed invention, a chassis may have more body connection components than are actually mated with a vehicle body. For example, a chassis may have ten load-bearing body-retention couplings, and be matable with a body that engages only five of the ten load-bearing body-retention couplings. Such an arrangement is particularly useful when an attachable body is of a different size than the chassis. For example, a matable body may be smaller than a chassis. Similarly, and within the scope of the claimed invention, a body may be modular such that separate body components or portions are independently connected to the vehicle chassis by the load-bearing body-retention couplings.

A body may have more complementary connection components than are engageable with the body connection components of a particular chassis. Such an arrangement may be employed to enable a particular body to be matable to multiple chassis each having a different predetermined spatial relationship among its body connection components.

The load-bearing body-retention couplings 89 and the electrical connector 91 are preferably releasably engageable without damage to either an attached body 85 or the chassis 10, thereby enabling removal of one body 85 from the chassis 10 and installation of a different body 85′, 85″ on the chassis 10.

In the preferred embodiment, the body-attachment interface 87 is characterized by the absence of any mechanical control signal-transmission linkages and any couplings for attaching mechanical control signal-transmission linkages. Mechanical control linkages, such as steering columns, limit the compatibility between a chassis and bodies of different configurations.

Referring to FIG. 1, the steering system 81 is housed in the front axle area 16 and is operably connected to the front wheels 73, 75. Preferably, the steering system 81 is responsive to non-mechanical control signals. In the preferred embodiment, the steering system 81 is by-wire. A by-wire system is characterized by control signal transmission in electrical form. In the context of the present invention, “by-wire” or X-by-wire systems, or systems that are controllable “by-wire,” include systems configured to receive control signals in electronic form via a control signal receiver on the body attachment interface 87, and respond in conformity to the electronic control signals.

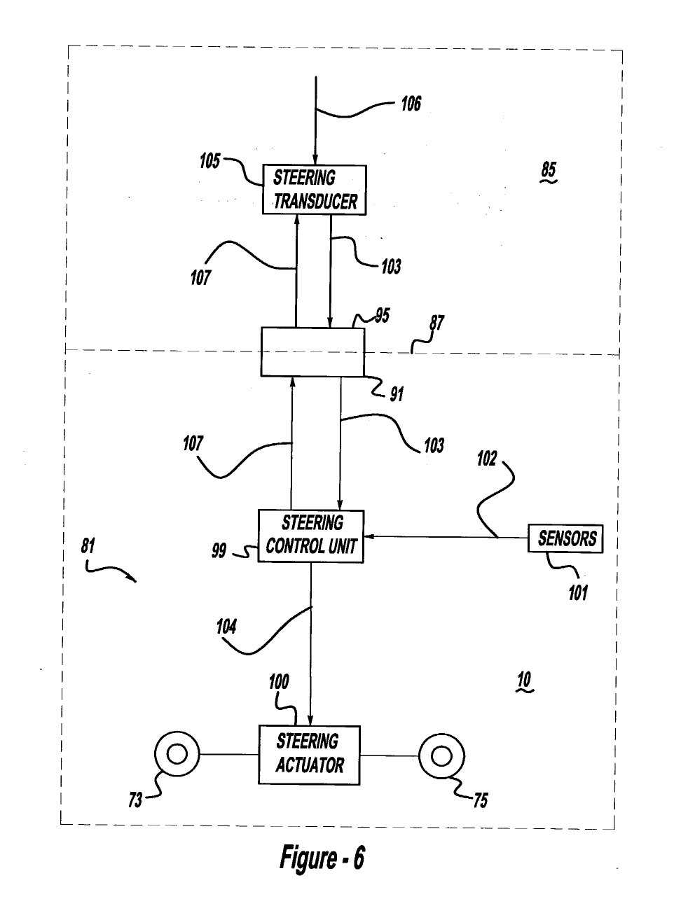

Referring to FIG. 6, the by-wire steering system 81 of the preferred embodiment includes a steering control unit 99, and a steering actuator 100. Sensors 101 are located on the chassis 10 and transmit sensor signals 102 carrying information concerning the state or condition of the chassis 10 and its component systems. The sensors 101 may include position sensors, velocity sensors, acceleration sensors, pressure sensors, force and torque sensors, flow meters, temperature sensors, etc. The steering control unit 99 receives and processes sensor signals 102 from the sensors 101 and electrical steering control signals 103 from the electrical connector 91, and generates steering actuator control signals 104 according to a stored algorithm. A control unit typically includes a microprocessor, ROM and RAM and appropriate input and output circuits of a known type for receiving the various input signals and for outputting the various control commands to the actuators. Sensor signals 102 may include yaw rate, lateral acceleration, angular wheel velocity, tie-rod force, steering angle, chassis velocity, etc.

The steering actuator 100 is operably connected to the front wheels 73, 75 and configured to adjust the steering angle of the front wheels 73, 75 in response to the steering actuator control signals 104. Actuators in a by-wire system transform electronic control signals into a mechanical action or otherwise influence a system's behavior in response to the electronic control signals. Examples of actuators that may be used in a by-wire system include electromechanical actuators such as electric servomotors, translational and rotational solenoids, magnetorheological actuators, electrohydraulic actuators, and electrorheological actuators. Those skilled in the art will recognize and understand mechanisms by which the steering angle is adjusted. In the preferred embodiment, the steering actuator 100 is an electric drive motor configured to adjust a mechanical steering rack.

Referring again to FIG. 6, the preferred embodiment of the chassis 10 is configured such that it is steerable by any source of compatible electrical steering control signals 103 connected to the electrical connector 91. FIG. 6 depicts a steering transducer 105 located on an attached vehicle body 85 and connected to a complementary electrical connector 95. Transducers convert the mechanical control signals of a vehicle driver to non-mechanical control signals. When used with a by-wire system, transducers convert the mechanical control signals to electrical control signals usable by the by-wire system. A vehicle driver inputs control signals in mechanical form by turning a wheel, depressing a pedal, pressing a button, or the like. Transducers utilize sensors, typically position and force sensors, to convert the mechanical input to an electrical signal. In the preferred embodiment, a +/−20 degree slide mechanism is used for driver input, and an optical encoder is used to read input rotation.

The complementary electrical connector 95 is coupled with the electrical connector 91 of the body attachment interface 87. The steering transducer 105 converts vehicle driver-initiated mechanical steering control signals 106 to electrical steering control signals 103 which are transmitted via the electrical connector 91 to the steering control unit 99. In the preferred embodiment, the steering control unit 99 generates steering feedback signals 107 for use by a vehicle driver and transmits the steering feedback signals 107 through the electrical connector 91. Some of the sensors 101 monitor linear distance movement of the steering rack and vehicle speed. This information is processed by the steering control unit 99 according to a stored algorithm to generate the steering feedback signals 107. A torque control motor operably connected to the slide mechanism receives the steering feedback signals 107 and is driven in the opposite direction of the driver's mechanical input.

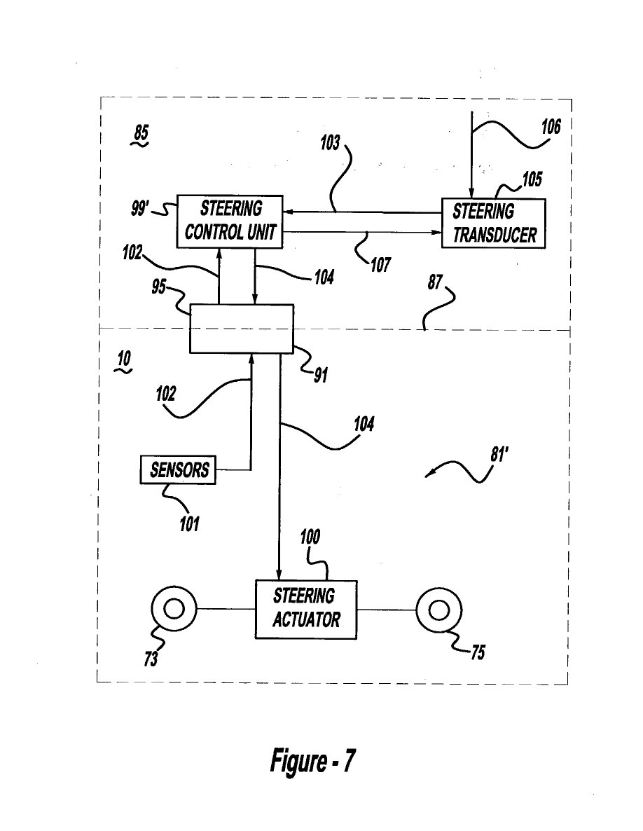

In the context of the present invention, a “by-wire” system may be an actuator connected directly to an electrical connector in the body attachment interface. An alternative by-wire steering system 81′ within the scope of the claimed invention is depicted schematically in FIG. 7, wherein like reference numbers refer to like components from FIG. 6. A steering actuator 100 configured to adjust the steering angle of the front wheels 73, 75 is connected directly to the electrical connector 91. In this embodiment, a steering control unit 99′ and a steering transducer 105 may be located in an attached vehicle body 85. The steering transducer 105 would transmit electrical steering control signals 103 to the steering control unit 99′, and the steering control unit 99′ would transmit steering actuator control signals 104 to the steering actuator 100 via the electrical connector 91. Sensors 101 positioned on the chassis 10 transmit sensor signals 102 to the steering control unit 99′ via the electrical connector 91 and the complementary electrical connector 95.

Examples of steer-by-wire systems are described in U.S. Pat. No. 6,176,341, issued Jan. 23, 2001 to Delphi Technologies, Inc; U.S. Pat. No. 6,208,923, issued Mar. 27, 2001 to Robert Bosch GmbH; U.S. Pat. No. 6,219,604, issued Apr. 17, 2001 to Robert Bosch GmbH; U.S. Pat. No. 6,318,494, issued Nov. 20, 2001 to Delphi Technologies, Inc.; U.S. Pat. No. 6,370,460, issued Apr. 9, 2002 to Delphi Technologies, Inc.; and U.S. Pat. No. 6,394,218, issued May 28, 2002 to TRW Fahrwerksysteme GmbH & Co. KG; which are hereby incorporated by reference in their entireties.

The steer-by-wire system described in U.S. Pat. No. 6,176,341 includes a position sensor for sensing angular position of a road wheel, a hand-operated steering wheel for controlling direction of the road wheel, a steering wheel sensor for sensing position of the steering wheel, a steering wheel actuator for actuating the hand-operated steering wheel, and a steering control unit for receiving the sensed steering wheel position and the sensed road wheel position and calculating actuator control signals, preferably including a road wheel actuator control signal and a steering wheel actuator control signal, as a function of the difference between the sensed road wheel position and the steering wheel position. The steering control unit commands the road wheel actuator to provide controlled steering of the road wheel in response to the road wheel actuator control signal. The steering control unit further commands the steering wheel actuator to provide feedback force actuation to the hand-operated steering wheel in response to the steering wheel control signal. The road wheel actuator control signal and steering wheel actuator control signal are preferably scaled to compensate for difference in gear ratio between the steering wheel and the road wheel. In addition, the road wheel actuator control signal and steering wheel actuator control signal may each have a gain set so that the road wheel control actuator signal commands greater force actuation to the road wheel than the feedback force applied to the steering wheel.

The steer-by-wire system described in U.S. Pat. No. 6,176,341 preferably implements two position control loops, one for the road wheel and one for the hand wheel. The position feedback from the steering wheel becomes a position command input for the road wheel control loop and the position feedback from the road wheel becomes a position command input for the steering wheel control loop. A road wheel error signal is calculated as the difference between the road wheel command input (steering wheel position feedback) and the road wheel position. Actuation of the road wheel is commanded in response to the road wheel error signal to provide controlled steering of the road wheel. A steering wheel error signal is calculated as the difference between the steering wheel position command (road wheel position feedback) and the steering wheel position. The hand-operated steering wheel is actuated in response to the steering wheel error signal to provide force feedback to the hand-operated steering wheel.

The steering control unit of the '341 system could be configured as a single processor or multiple processors and may include a general-purpose microprocessor-based controller, that may include a commercially available off-the-shelf controller. One example of a controller is Model No. 87C196CA microcontroller manufactured and made available from Intel Corporation of Delaware. The steering control unit preferably includes a processor and memory for storing and processing software algorithms, has a clock speed of 16 MHz, two optical encoder interfaces to read position feedbacks from each of the actuator motors, a pulse width modulation output for each motor driver, and a 5-volt regulator.

U.S. Pat. No. 6,370,460 describes a steer-by-wire control system comprising a road wheel unit and a steering wheel unit that operate together to provide steering control for the vehicle operator. A steering control unit may be employed to support performing the desired signal processing. Signals from sensors in the road wheel unit, steering wheel unit, and vehicle speed are used to calculate road wheel actuator control signals to control the direction of the vehicle and steering wheel torque commands to provide tactile feedback to the vehicle operator. An Ackerman correction may be employed to adjust the left and right road wheel angles correcting for errors in the steering geometry to ensure that the wheels will track about a common turn center.

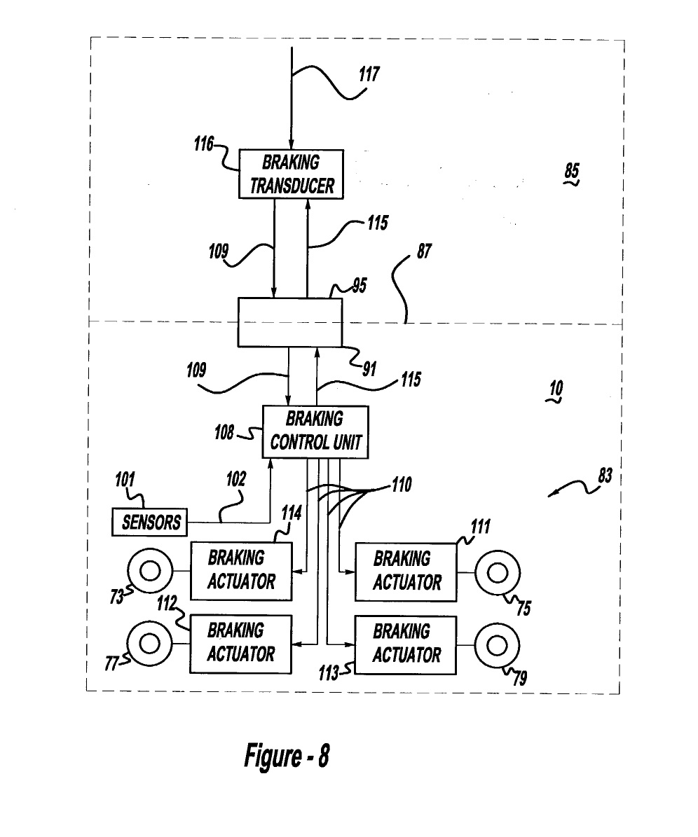

Referring again to FIG. 1, a braking system 83 is mounted to the structural frame 11 and is operably connected to the wheels 73, 75, 77, 79. The braking system is configured to be responsive to non-mechanical control signals. In the preferred embodiment, the braking system 83 is by-wire, as depicted schematically in FIG. 8, wherein like reference numbers refer to like components from FIGS. 6 and 7. Sensors 101 transmit sensor signals 102 carrying information concerning the state or condition of the chassis 10 and its component systems to a braking control unit 108. The braking control unit 108 is connected to the electrical connector 91 and is configured to receive electrical braking control signals 109 via the electrical connector 91. The braking control unit 108 processes the sensor signals 102 and the electrical braking control signals 109 and generates braking actuator control signals 110 according to a stored algorithm. The braking control unit 108 then transmits the braking actuator control signals 110 to braking actuators 111, 112, 113, 114 which act to reduce the angular velocity of the wheels 73, 75, 77, 79. Those skilled in the art will recognize the manner in which the braking actuators 111, 112, 113, 114 act on the wheels 73, 75, 77, 79. Typically, actuators cause contact between friction elements, such as pads and disc rotors. Optionally, an electric motor may function as a braking actuator in a regenerative braking system.

The braking control unit 108 may also generate braking feedback signals 115 for use by a vehicle driver and transmit the braking feedback signals 115 through the electrical connector 91. In the preferred embodiment, the braking actuators 111, 112, 113, 114 apply force through a caliper to a rotor at each wheel. Some of the sensors 101 measure the applied force on each caliper. The braking control unit 108 uses this information to ensure synchronous force application to each rotor.

Referring again to FIG. 8, the preferred embodiment of the chassis 10 is configured such that the braking system is responsive to any source of compatible electrical braking control signals 109. A braking transducer 116 may be located on an attached vehicle body 85 and connected to a complementary electrical connector 95 coupled with the electrical connector 91. The braking transducer 116 converts vehicle driver-initiated mechanical braking control signals 117 into electrical form and transmits the electrical braking control signals 109 to the braking control unit via the electrical connector 91. In the preferred embodiment, the braking transducer 116 includes two hand-grip type assemblies. The braking transducer 116 includes sensors that measure both the rate of applied pressure and the amount of applied pressure to the hand-grip assemblies, thereby converting mechanical braking control signals 117 to electrical braking control signals 109. The braking control unit 108 processes both the rate and amount of applied pressure to provide both normal and panic stopping.

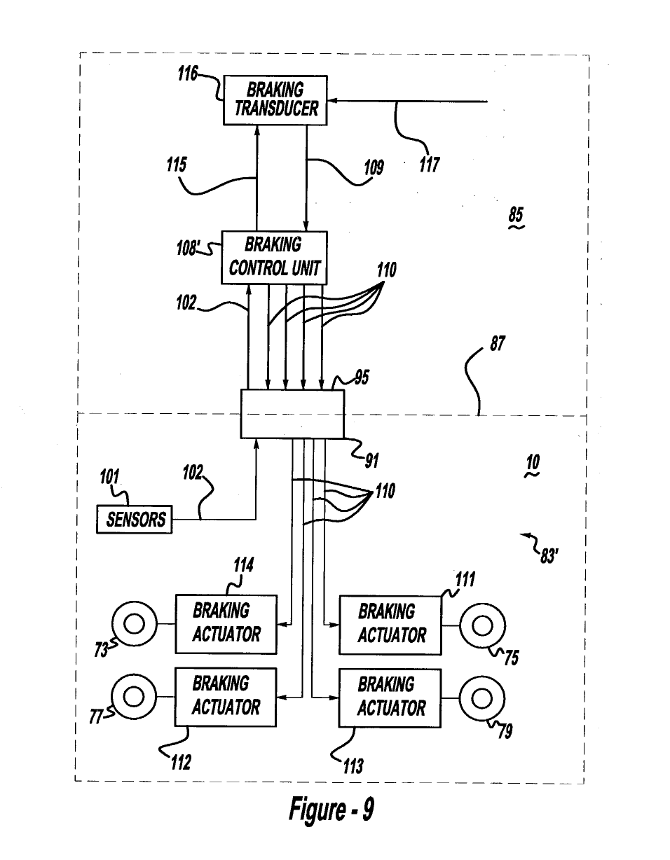

An alternative brake-by-wire system 83′ within the scope of the claimed invention is depicted in FIG. 9, wherein like reference numbers refer to like components from FIGS. 6-8. The braking actuators 111, 112, 113, 114 and sensors 101 are connected directly to the electrical connector 91. In this embodiment, a braking control unit 108′ may be located in an attached vehicle body 85. A braking transducer 116 transmits electrical braking control signals 109 to the braking control unit 108′, and the braking control unit 108′ transmits braking actuator signals 109 to the braking actuators 111, 112, 113, 114 via the electrical connector 91.

Examples of brake-by-wire systems are described in U.S. Pat. No. 5,366,281, issued Nov. 22, 2994 to General Motors Corporation; U.S. Pat. No. 5,823,636, issued Oct. 20, 1998 to General Motors Corporation; U.S. Pat. No. 6,305,758, issued Oct. 23, 2001 to Delphi Technologies, Inc.; and U.S. Pat. No. 6,390,565, issued May 21, 2002 to Delphi Technologies, Inc.; which are hereby incorporated by reference in their entireties.

The system described in U.S. Pat. No. 5,366,281 includes an input device for receiving mechanical braking control signals, a brake actuator and a control unit coupled to the input device and the brake actuator. The control unit receives brake commands, or electrical braking control signals, from the input device and provides actuator commands, or braking actuator control signals, to control current and voltage to the brake actuator. When a brake command is first received from the input device, the control unit outputs, for a first predetermined time period, a brake torque command to the brake actuator commanding maximum current to the actuator. After the first predetermined time period, the control unit outputs, for a second predetermined time period, a brake torque command to the brake actuator commanding voltage to the actuator responsive to the brake command and a first gain factor. After the second predetermined time period, the control unit outputs the brake torque command to the brake actuator commanding current to the actuator responsive to the brake command and a second gain factor, wherein the first gain factor is greater than the second gain factor and wherein brake initialization is responsive to the brake input.

U.S. Pat. No. 6,390,565 describes a brake-by-wire system that provides the capability of both travel and force sensors in a braking transducer connected to a brake apply input member such as a brake pedal and also provides redundancy in sensors by providing the signal from a sensor responsive to travel or position of the brake apply input member to a first control unit and the signal from a sensor responsive to force applied to a brake apply input member to a second control unit. The first and second control units are connected by a bi-directional communication link whereby each controller may communicate its received one of the sensor signals to the other control unit. In at least one of the control units, linearized versions of the signals are combined for the generation of first and second brake apply command signals for communication to braking actuators. If either control unit does not receive one of the sensor signals from the other, it nevertheless generates its braking actuator control signal on the basis of the sensor signal provided directly to it. In a preferred embodiment of the system, a control unit combines the linearized signals by choosing the largest in magnitude.

Referring again to FIG. 1, the energy storage system 69 stores energy that is used to propel the chassis 10. For most applications, the stored energy will be in chemical form. Examples of energy storage systems 69 include fuel tanks and electric batteries. In the embodiment shown in FIG. 1, the energy storage system 69 includes two compressed gas cylinder storage tanks 121 (5,000 psi, or 350 bars) mounted within the mid-chassis space 41 and configured to store compressed hydrogen gas. Employing more than two compressed gas cylinder storage tanks may be desirable to provide greater hydrogen storage capacity. Instead of compressed gas cylinder storage tanks 121, an alternate form of hydrogen storage may be employed such as metal or chemical hydrides. Hydrogen generation or reforming may also be used.

The energy conversion system 67 converts the energy stored by the energy storage system 69 to mechanical energy that propels the chassis 10. In the preferred embodiment, depicted in FIG. 1, the energy conversion system 67 includes a fuel cell stack 125 located in the rear axle area 18, and an electric traction motor 127 located in the front axle area 16. The fuel cell stack 125 produces a continuously available power of 94 kilowatts. Fuel cell systems for vehicular use are described in U.S. Pat. No. 6,195,999, issued Mar. 6, 2001 to General Motors Corporation; U.S. Pat. No. 6,223,843, issued May 1, 2001 to General Motors Corporation; U.S. Pat. No. 6,321,145, issued Nov. 20, 2001 to Delphi Technologies, Inc.; and U.S. Pat. No. 6,394,207, issued May 28, 2002 to General Motors Corporation; which are hereby incorporated by reference in their entireties.

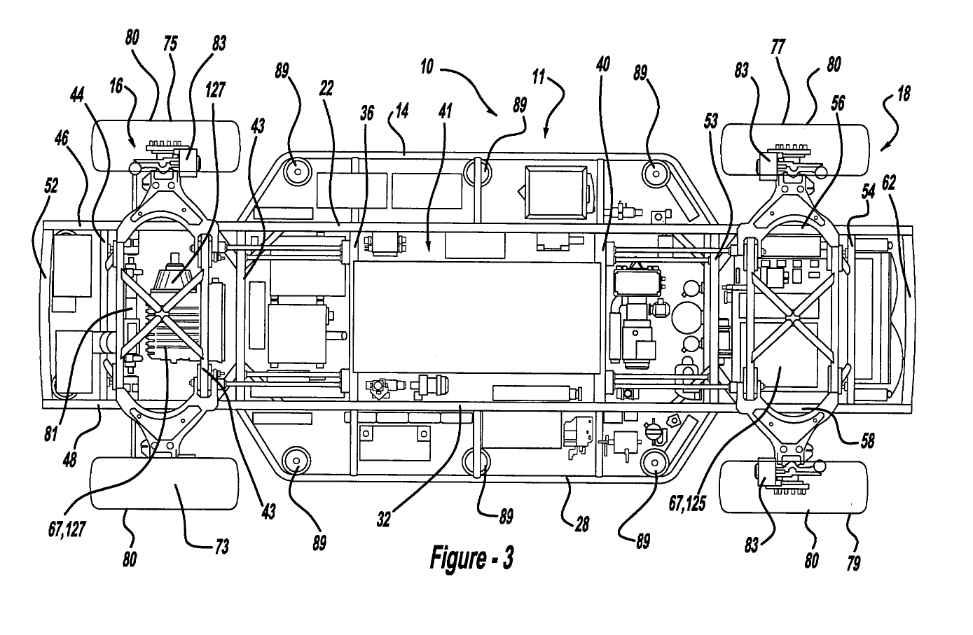

The fuel cell stack 125 is operably connected to the compressed gas cylinder storage tanks 121 and to the traction motor 127. The fuel cell stack 125 converts chemical energy in the form of hydrogen from the compressed gas cylinder storage tanks 121 into electrical energy, and the traction motor 127 converts the electrical energy to mechanical energy, and applies the mechanical energy to rotate the front wheels 73, 75. Optionally, the fuel cell stack 125 and traction motor 127 are switched between the front axle area 16 and rear axle area 18. Optionally, the energy conversion system includes an electric battery (not shown) in hybrid combination with the fiel cell to improve chassis acceleration. Other areas provided between the structural elements are useful for housing other mechanisms and systems for providing the functions typical of an automobile as shown in FIGS. 2 and 3. Those skilled in the art will recognize other energy conversion systems 67 that may be employed within the scope of the present invention.

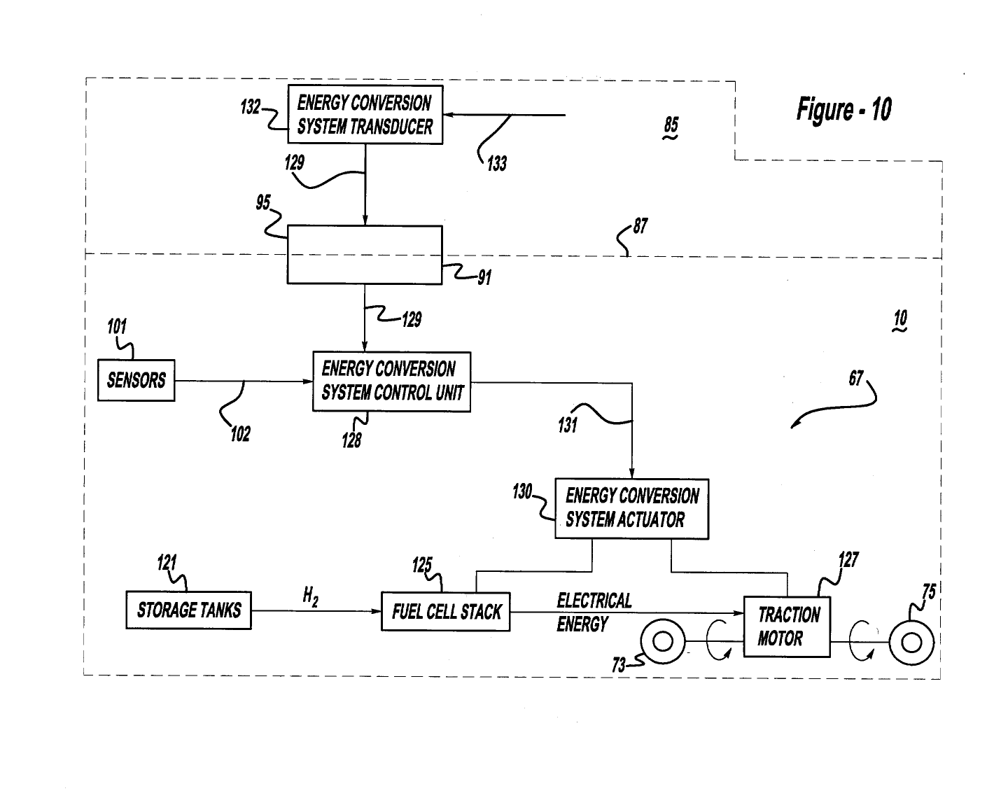

The energy conversion system 67 is configured to respond to non-mechanical control signals. The energy conversion system 67 of the preferred embodiment is controllable by-wire, as depicted in FIG. 10. An energy conversion system control unit 128 is connected to the electrical connector 91 from which it receives electrical energy conversion system control signals 129, and sensors 101 from which it receives sensor signals 102 carrying information about various chassis conditions. In the preferred embodiment, the information conveyed by the sensor signals 102 to the energy conversion system control unit 128 includes chassis velocity, electrical current applied, rate of acceleration of the chassis, and motor shaft speed to ensure smooth launches and controlled acceleration. The energy conversion system control unit 128 is connected to an energy conversion system actuator 130, and transmits energy conversion system actuator control signals 131 to the energy conversion system actuator 130 in response to the electrical energy conversion system control signals 129 and sensor signals 102 according to a stored algorithm. The energy conversion system actuator 130 acts on the fuel cell stack 125 or traction motor 127 to adjust energy output. Those skilled in the art will recognize the various methods by which the energy conversion system actuator 130 may adjust the energy output of the energy conversion system. For example, a solenoid may alternately open and close a valve that regulates hydrogen flow to the fuel cell stack. Similarly, a compressor that supplies oxygen (from air) to the fuel cell stack may function as an actuator, varying the amount of oxygen supplied to the fuel cell stack in response to signals from the energy conversion system control unit.

An energy conversion system transducer 132 may be located on a vehicle body 85 and connected to a complementary electrical connector 95 engaged with the electrical connector 91. The energy conversion system transducer 132 is configured to convert mechanical energy conversion system control signals 133 to electrical energy conversion system control signals 129.

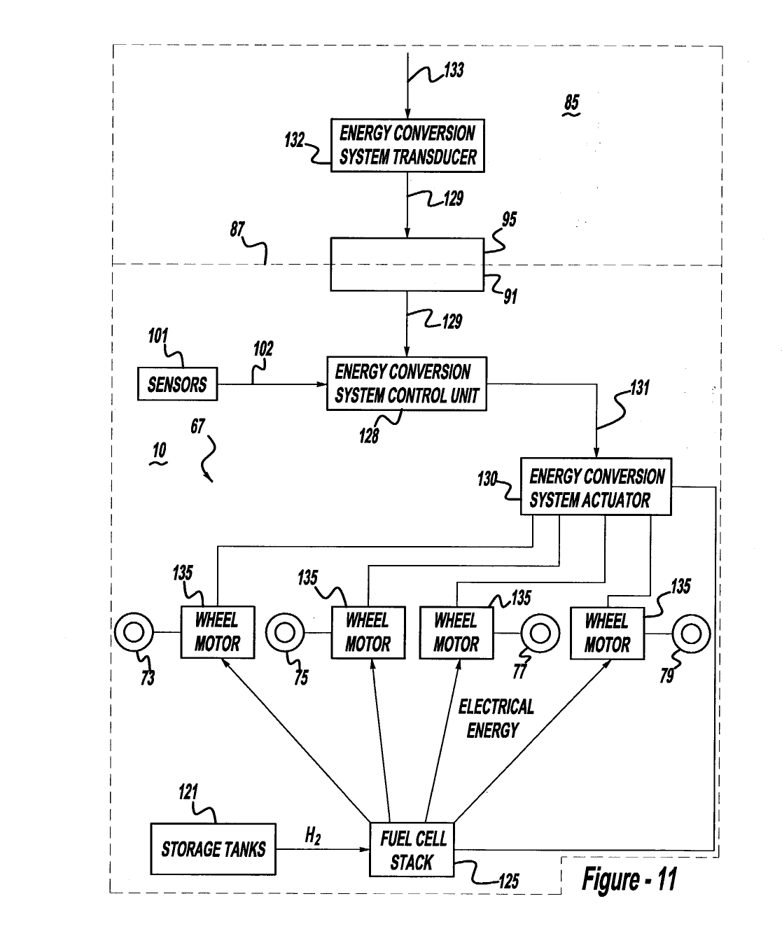

In another embodiment of the invention, as shown schematically in FIG. 11, wherein like reference numbers refer to like components from FIGS. 6-10, wheel motors 135, also known as wheel hub motors, are positioned at each of the four wheels 73, 75, 77, 79. Optionally, wheel motors 135 may be provided at only the front wheels 73, 75 or only the rear wheels 77, 79. The use of wheel motors 135 reduces the height of the chassis 10 compared to the use of traction motors, and therefore may be desirable for certain uses.

Referring again to FIG. 2, a conventional heat exchanger 137 and electric fan system 139, operably connected to the fuel cell stack 125 to circulate coolant for waste heat rejection, is carried in an opening that exists between the rear axle area 18 and the structural elements 54, 60. The heat exchanger 137 is set at an inclined angle to reduce its vertical profile, but to provide adequate heat rejection it also extends slightly above the top of elements 12, 26 (as seen in FIG. 4). Although the fuel cell stack 125, heat exchanger 137 and electric fan system 139 extend above the structural elements, their protrusion into the body pod space is relatively minor when compared to the engine compartment requirements of a conventionally designed automobile, especially when the chassis height of the preferred embodiment is approximately a mere 15 inches (28 centimeters). Optionally, the heat exchanger 137 is packaged completely within the chassis' structure with airflow routed through channels (not shown).

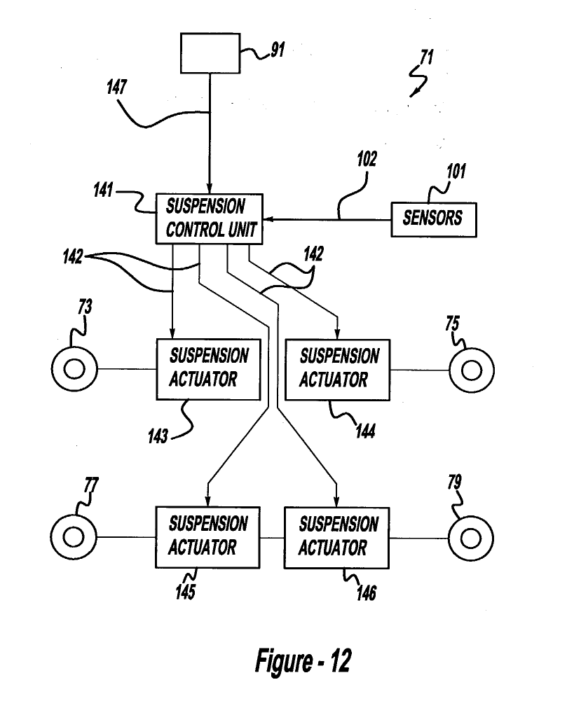

Referring again to FIG. 1, the suspension system 71 is mounted to the structural frame 11 and is connected to four wheels 73, 75, 77, 79. Those skilled in the art will understand the operation of a suspension system, and recognize that a multitude of suspension system types may be used within the scope of the claimed invention. The suspension system 71 of the preferred embodiment of the invention is electronically controlled, as depicted schematically in FIG. 12.

Referring to FIG. 12, the behavior of the electronically controlled suspension system 71 in response to any given road input is determined by a suspension control unit 141. Sensors 101 located on the chassis 10 monitor various conditions such as vehicle speed, angular wheel velocity, and wheel position relative to the chassis 10. The sensors 101 transmit the sensor signals 102 to the suspension control unit 141. The suspension control unit 141 processes the sensor signals 102 and generates suspension actuator control signals 142 according to a stored algorithm. The suspension control unit 141 transmits the suspension actuator control signals 142 to four suspension actuators 143, 144, 145, 146. Each suspension actuator 143, 144, 145, 146 is operably connected to a wheel 73, 75, 77, 79 and determines, in whole or in part, the position of the wheel 73, 75, 77, 79 relative to the chassis 10. The suspension actuators of the preferred embodiment are variable-force, real time, controllable dampers. The suspension system 71 of the preferred embodiment is also configured such that chassis ride height is adjustable. Separate actuators may be used to vary the chassis ride height.

In the preferred embodiment, the suspension control unit 141 is programmable and connected to the electrical connector 91 of the body-attachment interface 87. A vehicle user is thus able to alter suspension system 71 characteristics by reprogramming the suspension control unit 141 with suspension system software 147 via the electrical connector 91.

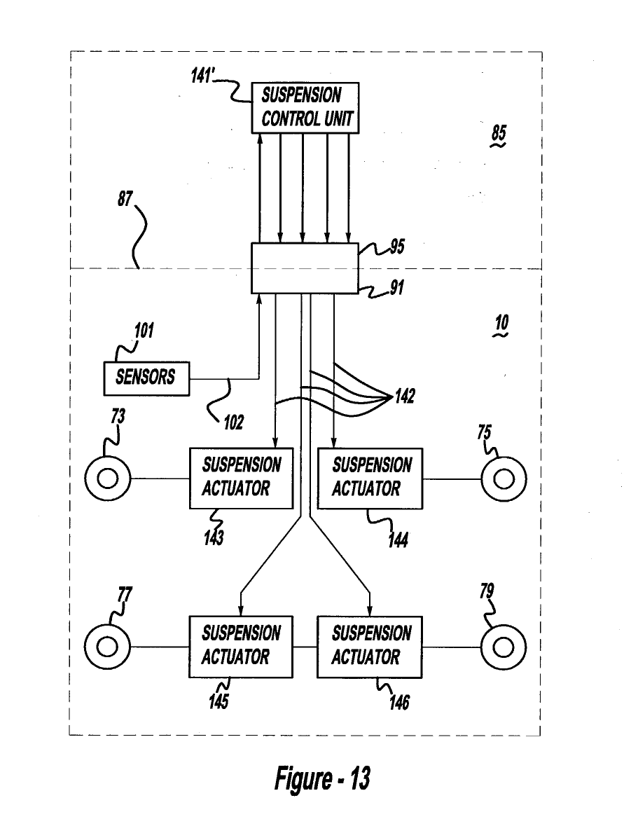

In the context of the claimed invention, electronically-controlled suspension systems include suspension systems without a suspension control unit located on the chassis 10. Referring to FIG. 13, wherein like reference numbers are used to reference like components from FIG. 12, suspension actuators 143, 144, 145, 146 and suspension sensors 101 are connected directly to the electrical connector 91. In such an embodiment, a suspension control unit 141′ located on an attached vehicle body 85 can process sensor signals 102 transmitted through the electrical connector 91, and transmit suspension actuator control signals 142 to the suspension actuators 143, 144, 145, 146 via the electrical connector 91.

Examples of electronically controlled suspension systems are described in U.S. Pat. No. 5,606,503, issued Feb. 25, 1997 to General Motors Corporation; U.S. Pat. No. 5,609,353, issued Mar. 11, 1997 to Ford Motor Company; and U.S. Pat. No. 6,397,134, issued May 28, 2002 to Delphi Technologies, Inc.; which are hereby incorporated by reference in their entireties.

U.S. Pat. No. 6,397,134 describes an electronically controlled suspension system that provides improved suspension control through steering crossover events. In particular, the system senses a vehicle lateral acceleration and a vehicle steering angle and stores, for each direction of sensed vehicle lateral acceleration, first and second sets of enhanced suspension actuator control signals for the suspension actuators of the vehicle. Responsive to the sensed vehicle lateral acceleration and sensed vehicle steering angle, the system applies the first set of enhanced actuator control signals to the suspension actuators if the sensed steering angle is in the same direction as the sensed lateral acceleration and alternatively applies the second set of enhanced actuator control signals to the suspension actuators if the sensed steering angle is in the opposite direction as the sensed lateral acceleration.

U.S. Pat. No. 5,606,503 describes a suspension control system for use in a vehicle including a suspended vehicle body, four un-suspended vehicle wheels, four variable force actuators mounted between the vehicle body and wheels, one of the variable force actuators at each corner of the vehicle, and a set of sensors providing sensor signals indicative of motion of the vehicle body, motion of the vehicle wheels, a vehicle speed and an ambient temperature. The suspension control system comprises a microcomputer control unit including: means for receiving the sensor signals; means, responsive to the sensor signals, for determining an actuator demand force for each actuator; means, responsive to the vehicle speed, for determining a first signal indicative of a first command maximum; means, responsive to the ambient temperature, for determining a second signal indicative of a second command maximum; and means for constraining the actuator demand force so that it is no greater than a lesser of the first and second command maximums.

Electrically conductive wires (not shown) are used in the preferred embodiment to transfer signals between the chassis 10 and an attached body 85, and between transducers, control units, and actuators. Those skilled in the art will recognize that other non-mechanical means of sending and receiving signals between a body and a chassis, and between transducers, control units, and actuators may be employed and fall within the scope of the claimed invention. Other non-mechanical means of sending and receiving signals include radio waves and fiber optics.

The by-wire systems are networked in the preferred embodiment, in part to reduce the quantity of dedicated wires connected to the electrical connector 91. A serial communication network is described in U.S. Pat. No. 5,534,848, issued Jul. 9, 1996 to General Motors Corporation, which is hereby incorporated by reference in its entirety. An example of a networked drive-by-wire system is described in U.S. Patent Application Publication No. US 2001/0029408, Ser. No. 09/775,143, which is hereby incorporated by reference in its entirety. Those skilled in the art will recognize various networking devices and protocols that may be used within the scope of the claimed invention, such as SAE J1850 and CAN (“Controller Area Network”). A TTP (“Time Triggered Protocol”) network is employed in the preferred embodiment of the invention for communications management.

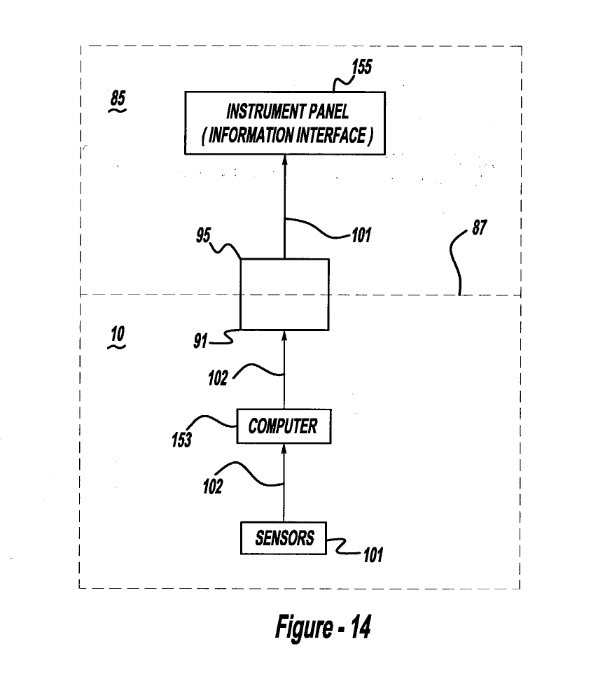

Some of the information collected by the sensors 101, such as chassis velocity, fuel level, and system temperature and pressure, is useful to a vehicle driver for operating the chassis and detecting system malfunctions. As shown in FIG. 14, the sensors 101 are connected to the electrical connector 91 through a chassis computer 153. Sensor signals 102 carrying information are transmitted from the sensors 101 to the chassis computer 153, which processes the sensor signals 102 according to a stored algorithm. The chassis computer 153 transmits the sensor signals 102 to the electrical connector 91 when, according to the stored algorithm, the sensor information is useful to the vehicle driver. For example, a sensor signal 102 carrying temperature information is transmitted to the electrical connector 91 by the chassis computer 153 when the operating temperature of the chassis 10 is unacceptably high. A driver-readable information interface 155 may be attached to a complementary electrical connector 95 coupled with the electrical connector 91 and display the information contained in the sensor signals 102. Driver-readable information interfaces include, but are not limited to, gauges, meters, LED displays, and LCD displays. The chassis may also contain communications systems, such as antennas and telematics systems, that are operably connected to an electrical connector in the body-attachment interface and configured to transmit information to an attached vehicle body.

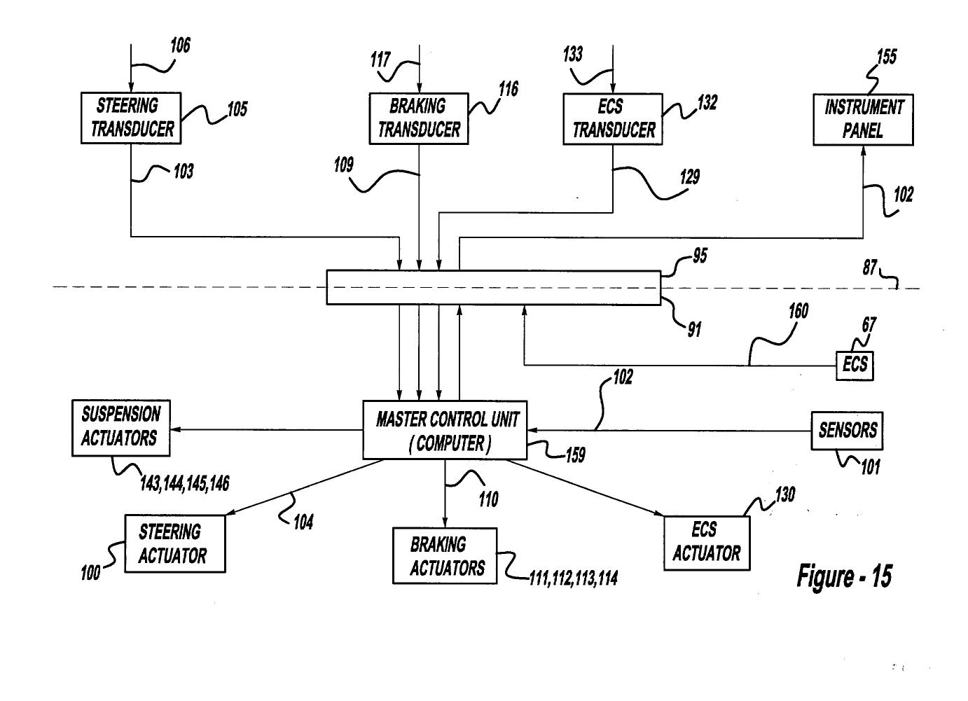

One control unit may serve multiple functions. For example, as shown in FIG. 15, a master control unit 159 functions as the steering control unit, braking control unit, suspension control unit, and energy conversion system control unit.

Referring again to FIG. 15, the energy conversion system 67 is configured to transmit electrical energy 160 to the electrical connector 91 to provide electric power for systems located on an attached vehicle body, such as power windows, power locks, entertainment systems, heating, ventilating, and air conditioning systems, etc. Optionally, if the energy storage system 69 includes a battery, then the battery may be connected to the electrical connector 91. In the preferred embodiment, the energy conversion system 67 includes a fuel cell stack that generates electrical energy and is connected to the electrical connector 91.

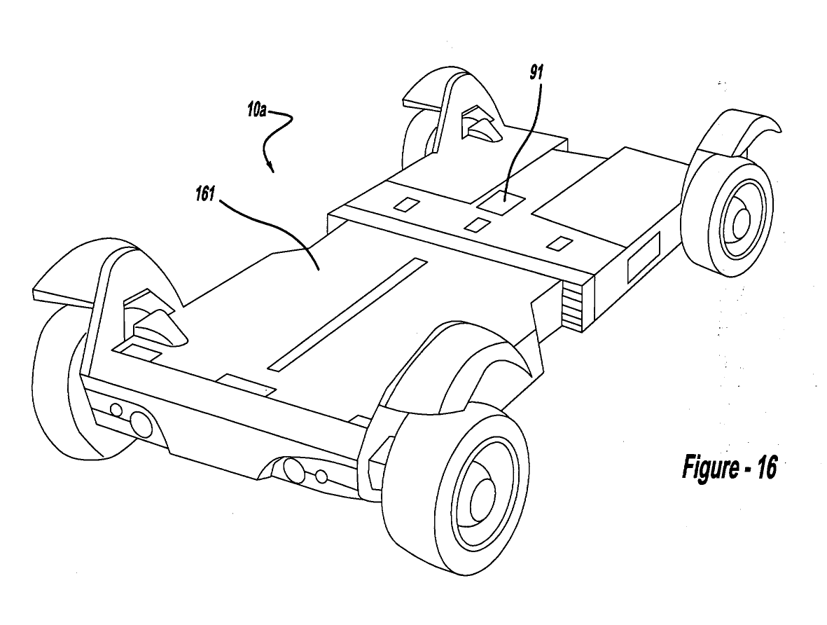

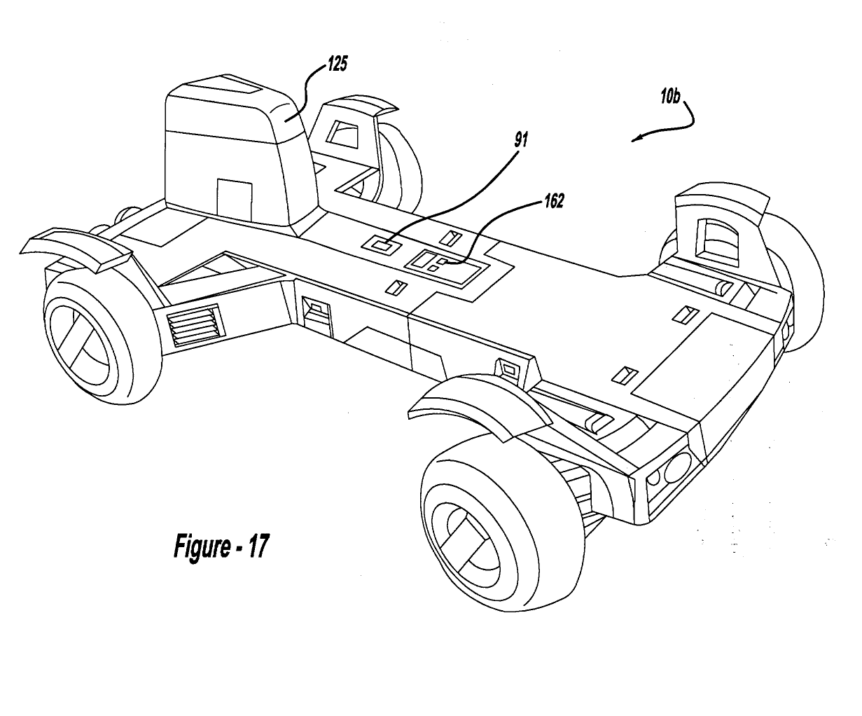

FIG. 16 shows a chassis 10 with rigid covering, or “skin,” 161 and an electrical connector or coupling 91 that functions as an umbilical port. The rigid covering 161 may be configured to function as a vehicle floor, which is useful if an attached vehicle body 85 does not have a lower surface. In FIG. 17, a similarly equipped chassis 10 is shown with an optional vertical fuel cell stack 125. The vertical fuel cell stack 125 protrudes significantly into the body pod space which is acceptable for some applications. The chassis 10 also includes a manual parking brake interface 162 that may be necessary for certain applications and therefore is also optionally used with other embodiments.

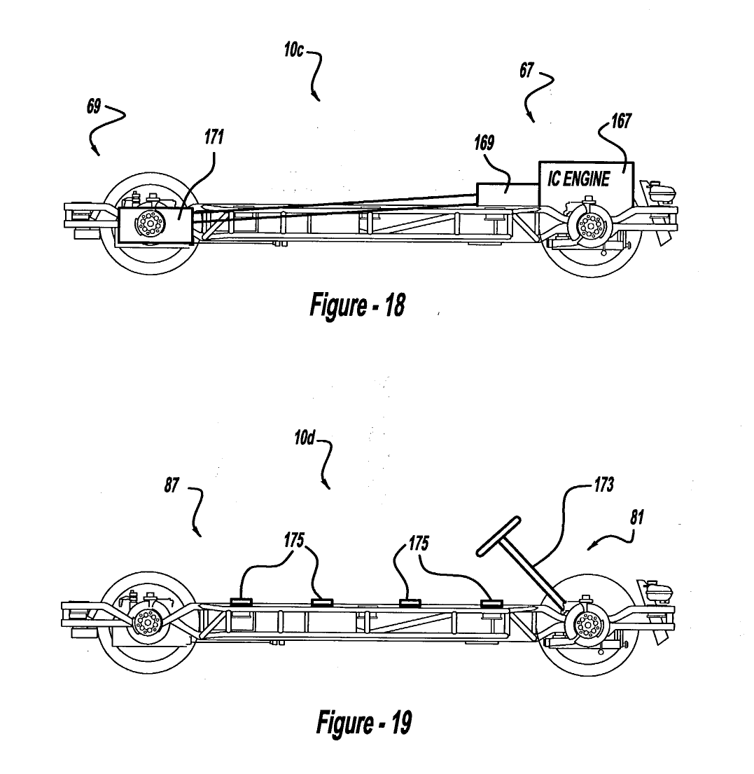

FIG. 18 depicts an embodiment of the invention that may be advantageous in some circumstances. The energy conversion system 67 includes an internal combustion engine 167 with horizontally-opposed cylinders, and a transmission 169. The energy storage system 69 includes a gasoline tank 171.

FIG. 19 depicts an embodiment of the invention wherein the steering system 81 has mechanical control linkages including a steering column 173. Passenger seating attachment couplings 175 are present on the body attachment interface 87, allowing the attachment of passenger seating assemblies to the chassis 10.

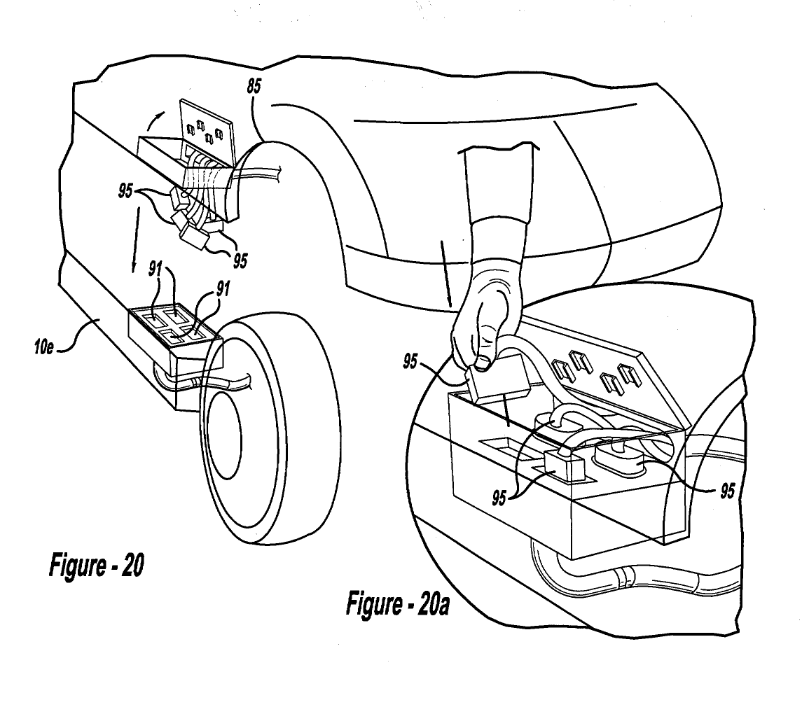

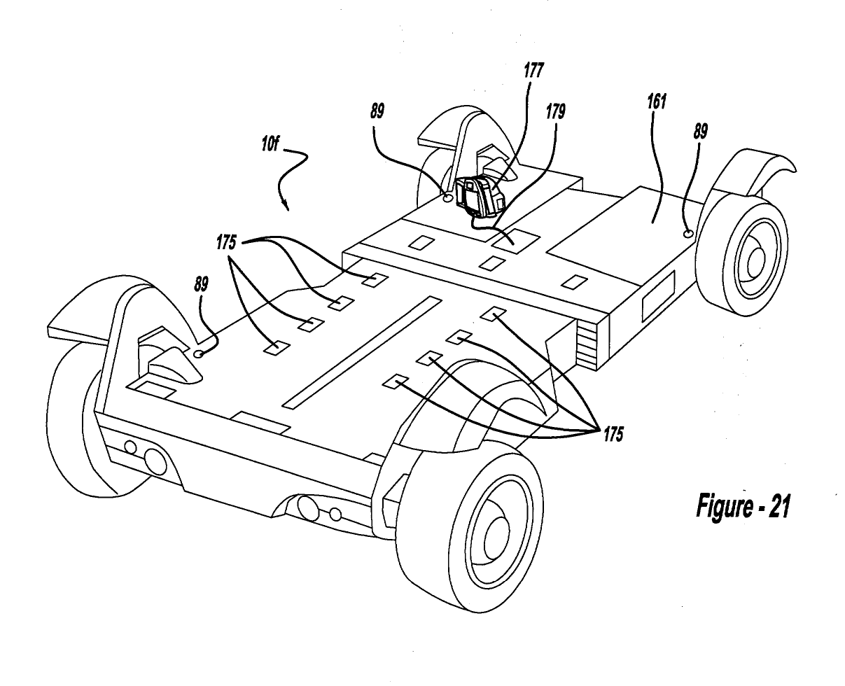

FIGS. 20 and 20a depict a chassis 10 within the scope of the invention and a body 85 each having multiple electrical connectors 91 and multiple complementary electrical connectors 95, respectively. For example, a first electrical connector 91 may be operably connected to the steering system and function as a control signal receiver. A second electrical connector 91 may be operably connected to the braking system and function as a control signal receiver. A third electrical connector 91 may be operably connected to the energy conversion system and function as a control signal receiver. A fourth electrical connector 91 may be operably connected to the energy conversion system and function as an electrical power connector. Four multiple wire in-line connectors and complementary connectors are used in the embodiment shown in FIGS. 20 and 20a. FIG. 20a depicts an assembly process for attaching corresponding connectors 91, 95.

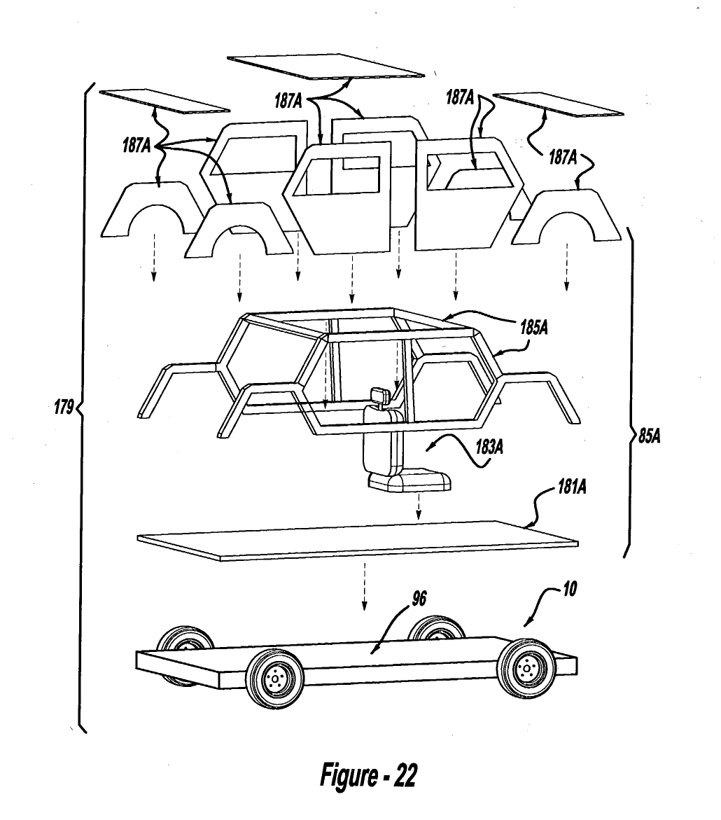

Referring to FIG. 21, a further embodiment of the invention is depicted. The chassis 10 has a rigid covering 161 and a plurality of passenger seating attachment couplings 175. A driver-operable control input device 177 containing a steering transducer, a braking transducer, and an energy conversion system transducer, is operably connected to the steering system, braking system, and energy conversion system by wires 179 and movable to different attachment points.

The embodiment depicted in FIG. 21 enables bodies of varying designs and configurations to mate with a common chassis design. A vehicle body without a lower surface but having complementary attachment couplings is matable to the chassis 10 at the load-bearing body retention couplings 89. Passenger seating assemblies may be attached at passenger seating attachment couplings 175.

FIG. 22 shows a vehicle 179 prior to being assembled according to a method described herein. The vehicle 179 includes vehicle body 85A. The invention contemplates that the body 85A includes a configuration such as vehicle body 85 shown in FIG. 5 wherein chassis 10 includes load bearing body retention couplings 89 and the body 85 includes complementary attachment couplings 93 to physically fasten the vehicle body 85 to the chassis 10.

The vehicle 179 includes a vehicle chassis 10. The preassembled chassis 10 includes a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel. Such a chassis is shown in FIG. 1, including structural frame 11 and wheels 73, 75, 77, 79. FIG. 1 also shows systems responsive to non-mechanical control signals including an energy conversion system 67, a steering system 81, and a braking system 83. The preassembled chassis 10 depicted in FIG. 22 has an upper face 96 as shown on the chassis 10 depicted in FIG. 5.

The vehicle body 85A includes a floor 181A adapted to be operably connectable to the chassis 10. The vehicle body 85A also includes a seating apparatus 183A adapted to be operably connectable to the chassis 10. The vehicle body 85A further includes a body frame 185A adapted to be operably connectable to the chassis 10. Additionally, the vehicle body 85A includes a plurality of body panels 187A adapted to be operably connectable to the body frame 185A.

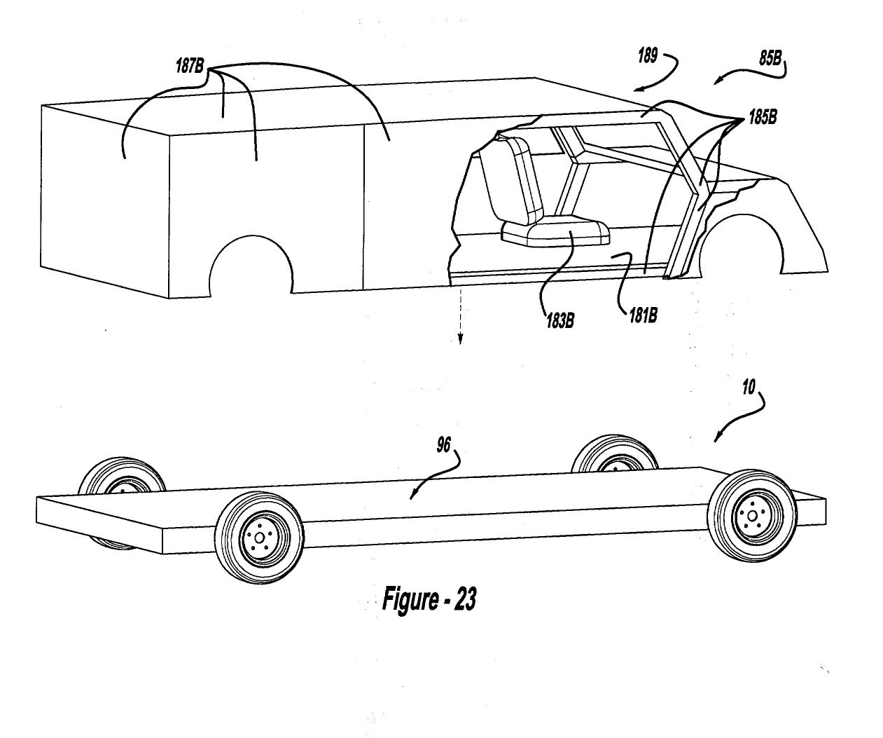

Referring to FIG. 23, wherein like reference numbers refer to like components from FIGS. 1-22, the invention contemplates a body 85B that is a preassembled body module 189. The body 85B includes body frame 185B and seating apparatus 183B both of which are operatively connected to a floor 181B, as well as body panels 187B that are operatively connected to the body frame 185B.

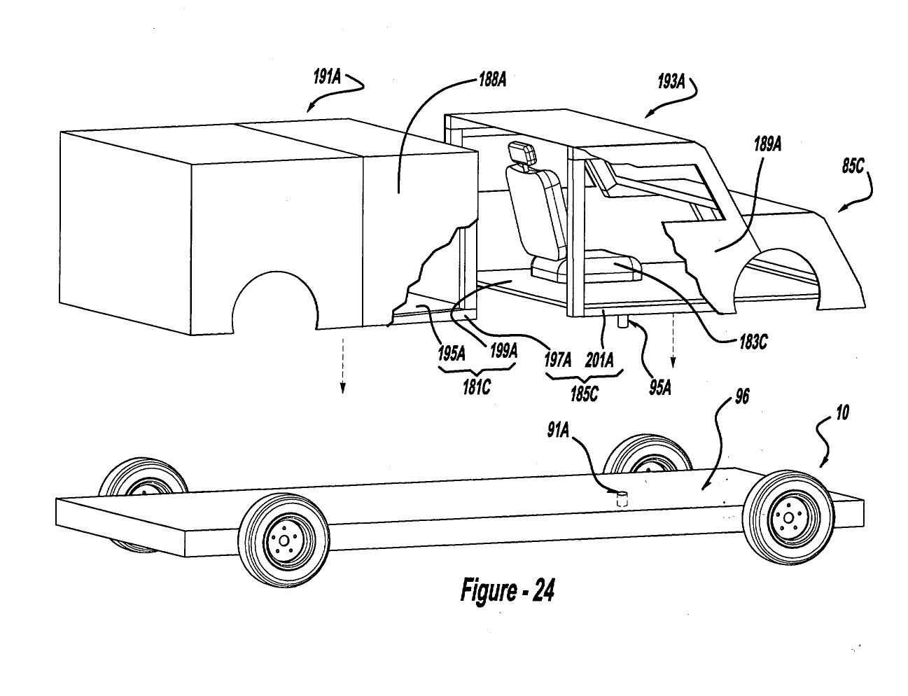

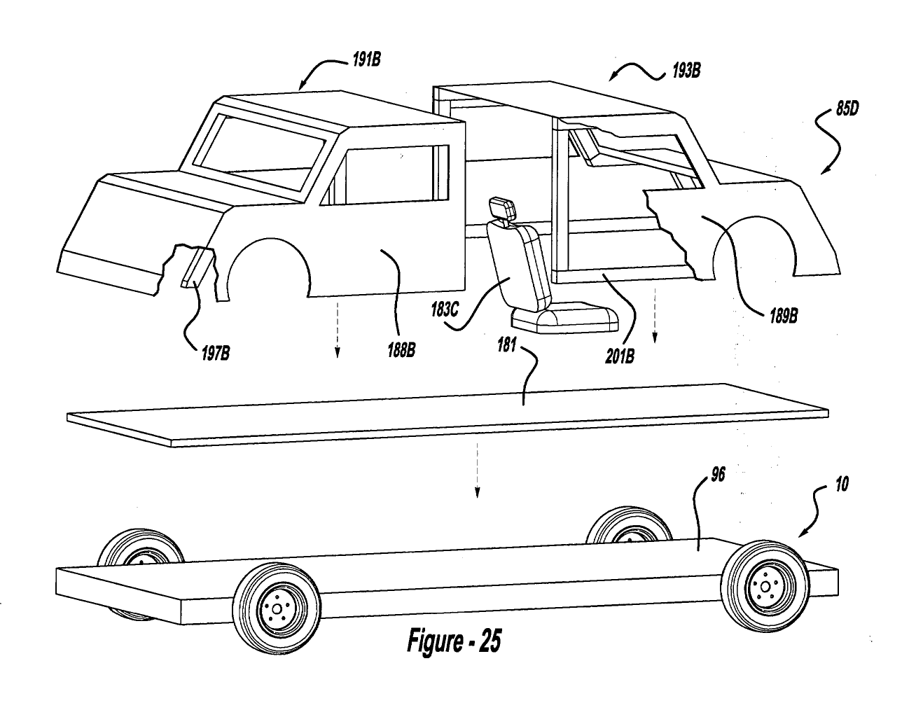

Referring to FIG. 24, wherein like reference numbers refer to like components from FIGS. 1-23, the invention contemplates a body 85C that includes two preassembled body modules, a first preassembled body module 191A, and a second preassembled body module 193A. The first preassembled body module 191A has a first floor portion 195A, a first body frame portion 197A that is operatively connected to the first floor portion 195A, and a first body panel 188A that is operatively connected to the first body frame portion 197A. The second preassembled body module 193A includes a second floor portion 199A, a second body frame portion 201A, a second body panel 189A that is operatively connected to the second body frame portion 201A, and a seating apparatus 183C that is operatively connected to the second floor portion 199A. The first floor portion 195A and the second floor portion 199A each partially form a floor 181C. The first body frame portion 197A and the second body frame portion 201A each partially form a body frame 185C. The first body frame portion 197A is operatively connected to the first floor portion 195A. The second body frame portion 201A is operatively connected to the second floor portion 199A. The space or gap shown between body modules 191A and 193A is exaggerated for purposes of clarity. The modules may be more closely positioned with respect to one another during assembly. Additionally, the relative sizes of the modules and the chassis are representational only; the sizes of the modules would be scaled for proper alignment and coverage of the chassis.

As discussed above with respect to FIG. 4, the chassis 10 includes at least one electrical connector 91 that is engageable with a complementary electrical connector 95 on the vehicle body 85. Referring to FIG. 24, an electrical connector 91A that is substantially the same as electrical connector 91, and a complementary electrical connector 95 that is substantially the same as electrical connector 95A are shown on the chassis 10 and on the body module 85C, respectively. Preferably, the electrical connector 91A and the complementary electrical connector 95A are located sufficiently in alignment with respect to each other such that, when the body is mounted at the upper face of the chassis, the complementary electrical connector 95A will be engageable with the electrical connector 91A. Thus, in this embodiment of the invention, the body is operatively connected to the chassis when it is mounted at the upper face of the chassis so that the braking system, the steering system and the energy conversion system are responsive to respective control signals in the manner discussed with respect to FIGS. 6-11 above.

Referring to FIG. 25, wherein like reference numbers refer to like components from FIGS. 1-24, the invention contemplates a body 85D which includes a first preassembled body module 191B and a second preassembled body module 193B. The first preassembled body module 191B includes a first body frame portion 197B and a first body panel 188B that is operatively connected to a first body frame portion 197B. The second preassembled body module 193B includes a second body frame portion 201B and a second body panel 189B that is operatively connected to the second body frame portion 201B. The space or gap shown between the body modules 1911B and 193B and the relative sizes of the body modules with respect to the chassis are representational only; the body modules may be more closely positioned and the overall sizes of the body modules would ensure proper alignment with and coverage of the chassis, as discussed with respect to the body modules and chassis depicted in FIG. 24 above.

The invention contemplates that the vehicle bodies 85A, 85B, 85C, 85D and the body modules 189, 191A, 191B, 193A, 193B may be formed by a quick-plastic forming method, a super-plastic forming method or a hydroforming method. Quick plastic forming is described in U.S. Pat. No. 6,253,588, issued Jul. 3, 2001 to Rashid, et al, which is hereby incorporated by reference in its entirety. Superplastic forming is described in U.S. Pat. No. 5,974,847, issued Nov. 2, 1999 to Saunders, et al, which is hereby incorporated by reference in its entirety. Hydroforming is also a feasible method of forming vehicle bodies and body modules.

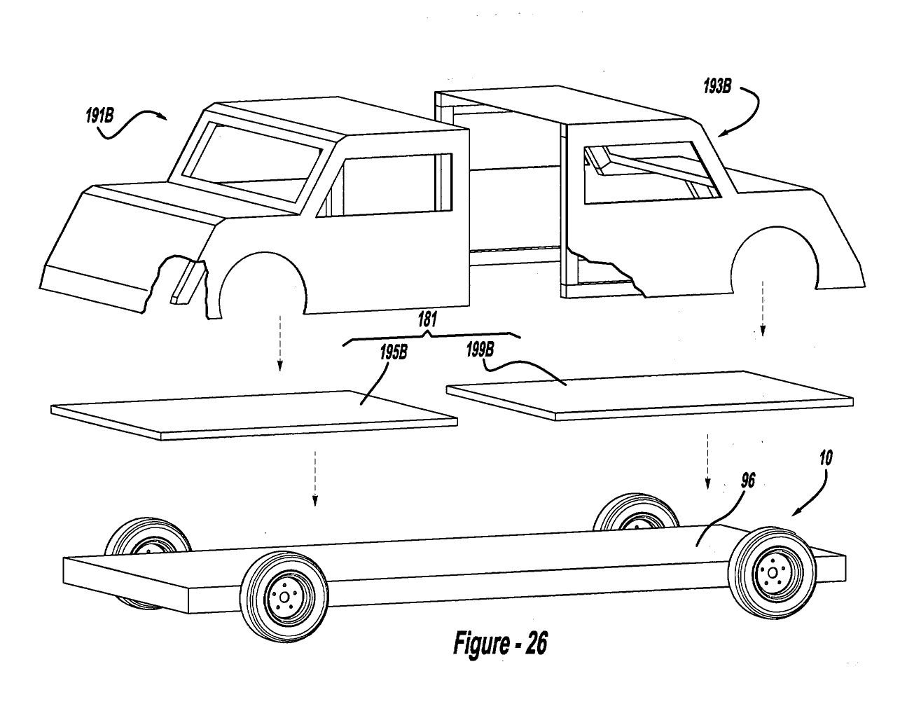

Referring to FIG. 26, wherein like reference numbers refer to like components from FIGS. 1-25, the invention contemplates that the floor 181 may include a first floor portion 195B and a second floor portion 199B both of which at least partially form the floor 181. The floor portions 195B, 199B shown in FIG. 26 are not integral to body modules 191B, 193B, unlike floor portions 195A and 199A shown in FIG. 24, which are integral to modules 191A and 193A.

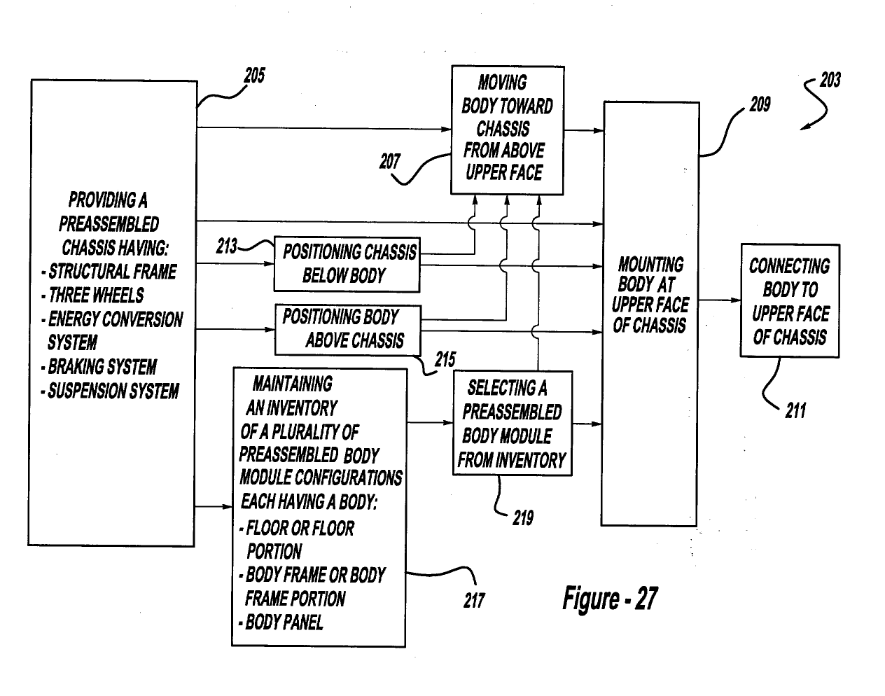

FIG. 27 illustrates a method 203 of assembling vehicles. The method 203 includes providing a preassembled chassis 205 having a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel. Such a chassis is depicted in FIG. 1 and in FIG. 22 and is described in the discussion herein with respect to those Figures. The method 203 further includes moving the body 207 toward the chassis from a direction above the upper face of the chassis. The invention contemplates that acts included in method 203 that are performed on the body may also be performed on body modules if the body is made up in whole or in part of the body modules depicted in FIGS. 23-26 and discussed herein with respect to those Figures. Referring back to FIG. 22, a body 85A is shown above an upper face 96 of the chassis 10. The phantom arrows shown in FIG. 22 depict the motion of the body 85A toward the upper face 96 of the chassis 10.

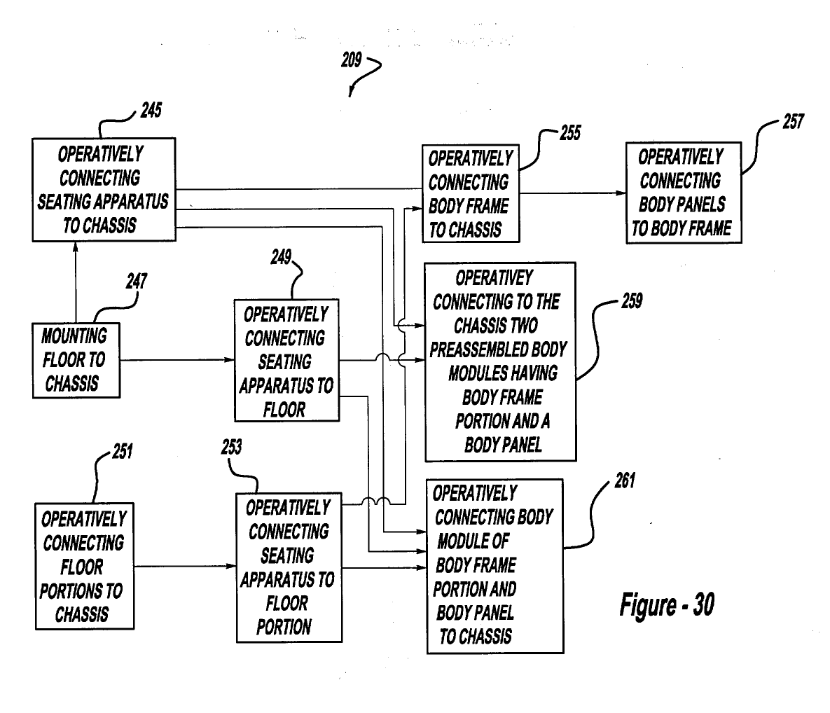

Referring again to FIG. 27, the method 203 further includes mounting the body at the upper face of the chassis 209. Mounting the body 209 is depicted in FIG. 30 and is discussed in further detail with respect thereto below. Those skilled in the art will recognize a variety of ways to accomplish mounting the body at the upper face. As discussed herein with respect to FIG. 5, in a preferred embodiment of the body and the chassis, the body 85 has complementary attachment couplings 93 that are matable with load-bearing body-retention couplings 89 exposed at the upper face 96 of the chassis 10.

The method 203 further includes connecting the body to the upper face of the chassis 211. As discussed herein with respect to FIG. 5, in a preferred embodiment, the load-bearing vehicle-retention couplings 89 are releasably engageable with the body 85. However, the invention contemplates a variety of means for connecting the body to the chassis, including means wherein the body and chassis are not releasably engageable, such as welding. Those skilled in the art will recognize a variety of connection mechanisms sufficient for connecting the body and chassis.

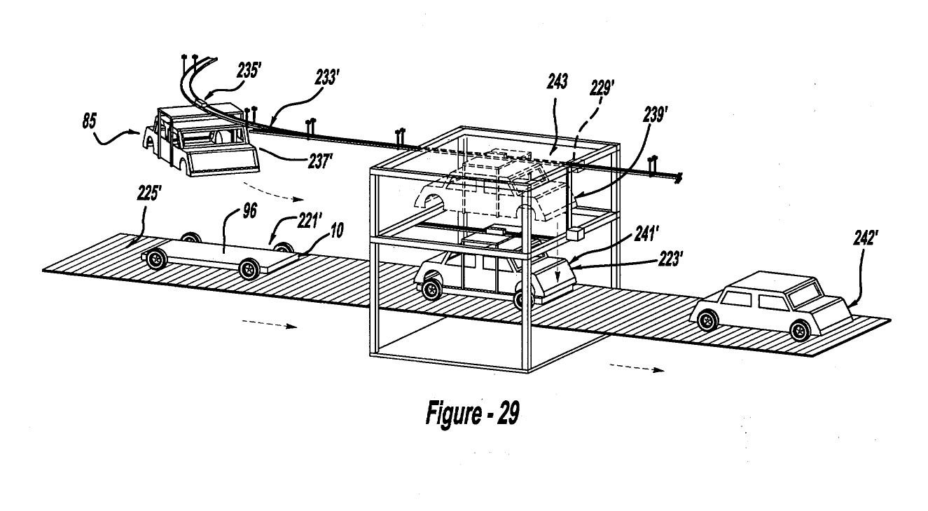

Referring again to FIG. 27, the method 203 further includes positioning the chassis below the body 213 prior to mounting the body at an upper face of the chassis 209. The method 203 further includes positioning the body above the chassis 215 prior to mounting the body at an upper face of the chassis 209. Positioning the chassis below the body 213 and positioning the body above the chassis 215 are discussed in greater detail below with respect to FIGS. 29 and 30 wherein these acts are depicted.

The method 203 further includes maintaining an inventory 217 of a plurality of preassembled body module configurations each having a floor or a floor portion, a body frame or a body frame portion, and a body panel. Such modules are described in the discussion above with respect to FIGS. 23 and 24, and are depicted in FIG. 23 as preassembled module 189, and in FIG. 24 as first preassembled module 191A and as second preassembled module 193A. The method 203 further includes selecting a preassembled module from the inventory 219. Maintaining an inventory of preassembled modules 217 and selecting a preassembled module from the inventory 219 occur prior to mounting a body or body module at an upper face of the chassis 209 in the method 203.

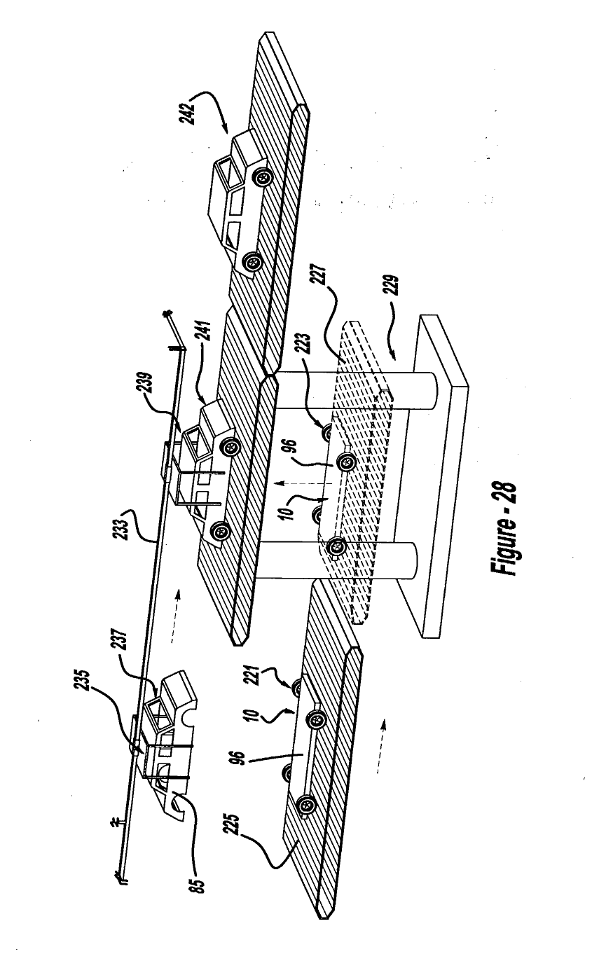

Referring to FIG. 28, wherein like reference numbers refer to like components from FIGS. 1-27, positioning the chassis below the body 213 prior mounting the body at the upper face of the chassis 209 is depicted. The invention may include positioning the chassis below the body using automated means. Within the scope of the invention, automated means include a conveyor system. Additionally, automated means include an hydraulic lift. In FIG. 28, the vehicle chassis 10 having an upper face 96 is shown in a first chassis position 221 on a roller belt conveyor system 225. The conveyor system 225 moves the chassis 10 to a second chassis position 223 on a portion of the conveyor system 227 attached to an hydraulic lift 229.

FIG. 28 also depicts a vehicle body 85 suspended from an overhead rail conveyor system 233 including a transporting mechanism 235 that moves the body 85 from a first body position 237 to a second body position 239. When the body 85 is in the second body position 239, positioning the chassis below the body 213 is accomplished by moving the chassis 10 into the second chassis position 223 using the roller belt conveyor system 225 and then using the hydraulic lift 229 to lift the portion of the conveyor system 227 so that the chassis 10 is moved into a third chassis position 241. When the chassis 10 is in the third chassis position 241 and the vehicle body 85 is in the second body position 239, mounting the body at the upper face of the chassis 209 and connecting the body to the upper face of the chassis 211 occur prior to the chassis 10 and body 85 moving to a fourth chassis position 242. The phantom arrow shown between the second chassis position 223 and the third chassis position 241 illustrate an aspect of the invention wherein mounting the body 85 is facilitated by relative movement between the body 85 and chassis 10. The relative movement depicted is chassis 10 toward body 85 and the movement of the chassis 10 is up.

Referring to FIG. 29, wherein like reference numbers refer to like components from FIGS. 1-28, positioning the chassis below the body 213 prior mounting the body at the upper face of the chassis 209 is depicted. The invention includes positioning the body above the chassis using automated means. Within the scope of the invention, automated means include a conveyor system. Additionally, automated means include an hydraulic or other actuatable lift. In FIG. 29, the vehicle body 85 is suspended from an overhead rail conveyor system 233′ including a transporting mechanism 235′ that moves the body 85 from a first body position 237′ to a second body position 239′.

FIG. 29 also depicts the vehicle chassis 10 having an upper face 96 in a first chassis position 221′ on a roller belt conveyor system 225′. The conveyor system 225′ moves the chassis 10 to a second chassis position 223′. When the chassis 10 is in the second chassis position 223′, positioning the body above the chassis is accomplished by moving the body 85 into the second body position 239′ and then using an hydraulic lift system 229′ attached to a portion of the overhead rail conveyor system 243 to lower the body 85 to a third body position 241′. When the chassis 10 is in the second chassis position 223′ and the vehicle body 85 is in the third body position 241′, mounting the body at the upper face of the chassis 209 and connecting the body to the upper face of the chassis 211 occur prior to the chassis and body moving to a fourth chassis position 242′. The phantom arrow shown between the second body position 239′ and the third body position 241′ illustrate an aspect of the invention wherein mounting the body 85 is facilitated by relative movement between the body 85 and chassis 10. The relative movement depicted is body 85 toward chassis 10 and the movement of the body 85 is down. The phantom arrow also depicts an aspect of the invention wherein mounting the body 85 at the upper face 96 of the preassembled chassis 10 includes moving the body 85 toward the chassis 10 from a direction above the upper face 96 of the chassis 10.

Referring to FIG. 30, wherein like reference numbers refer to like components in FIGS. 1-29, mounting the body at the upper face of the chassis 209 may encompass several acts within the scope of the invention. For example, operatively connecting the seating apparatus to the chassis 245 may be included in mounting the body at the upper face of the chassis 209. In a chassis configuration as depicted in FIG. 21, wherein the chassis includes a rigid covering 161 and passenger seat attachment couplings 175, a body without a lower surface, i.e., a body without a floor, operatively connecting the seating apparatus to the chassis 245 is included within mounting the body at the upper face of the chassis 245.

If the body includes a floor, mounting the floor to the chassis 247 may also be included in mounting the body at the upper face of the chassis 209. In that instance, operatively connecting the seating apparatus to the floor 249 may occur as an alternative to operatively connecting the seating apparatus to the chassis 245. If the body includes a floor that is made up of floor portions, as depicted in FIG. 26, then mounting the body at the upper face of the chassis 209 may include operatively connecting the floor portions to the chassis 251. In this instance, operatively connecting the seating apparatus to one of the floor portions 253 may occur as an alternative to operatively connecting the seating apparatus to the chassis 245.

Mounting the body at the upper face of the chassis 209 may further include operatively connecting the body frame to the chassis 255. As discussed herein with respect to FIG. 5 and with respect to FIG. 27, the invention contemplates, and those skilled in the art will recognize, a variety of mechanisms for connecting the body to the chassis. Mounting the body at the upper face of the chassis 209 may further include operatively connecting body panels to the body frame 257.

As operatively connecting the seating apparatus to the chassis 245, mounting the floor to the chassis 247, and operatively connecting the floor portions to the chassis 251, operatively connecting the body frame to the chassis 255, may be included within mounting the body at the upper face of the chassis 209, the invention contemplates that such mounting or operatively connecting is accomplished at the upper face of the chassis.

If the body includes two preassembled body modules each having a body frame portion and a body panel operatively connected to the body frame portion, as discussed herein with respect to FIG. 25 and with respect to FIG. 26, mounting the body at the upper face of the chassis 209 may further include operatively connecting the two preassembled modules to the chassis 259, and, accordingly, this operatively connecting would be accomplished at the upper face of the chassis.

If the body is a preassembled body module having a floor, a body frame and at least one seating apparatus operatively connected to the floor, and a body panel operatively connected to the body frame portion, as discussed herein with respect to FIG. 23, mounting the body at the upper face of the chassis 209 may further include operatively connecting the preassembled module to the chassis 261, and, accordingly, this operatively connecting would be accomplished at the upper face of the chassis.

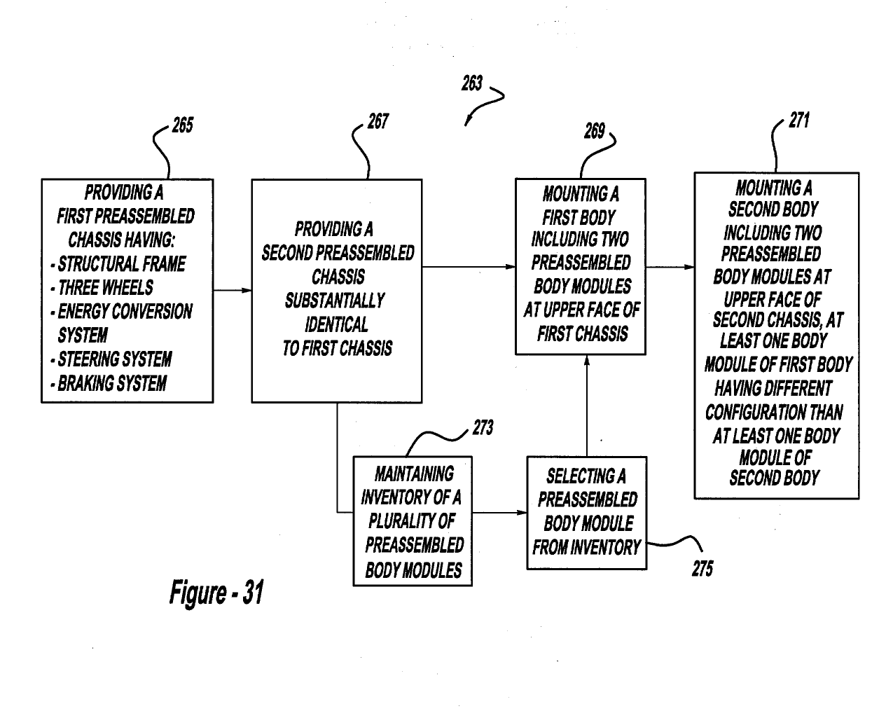

Referring to FIG. 31, wherein like reference numbers refer to like components in FIGS. 1-30, the invention contemplates a method of assembling vehicles 263. The method of assembling vehicles 263 includes providing a first preassembled chassis 265 and providing a second preassembled chassis 267. The chassis provided are as discussed with respect to FIG. 1 and FIG. 22 herein, each having a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel.

The method of assembling vehicles further includes mounting a first body 269 including at least two preassembled body modules at the upper face of the first chassis. The method includes mounting a second body 271 including at least two preassembled body modules at the upper face of the second chassis. At least one of the preassembled body modules included in the first body has a different configuration than at least one of the preassembled body modules included in the second body.

The preassembled body modules included in the first body and in the second body include a body frame portion at least partially forming a body frame, and at least one body panel operatively connected to the body frame portion. The invention contemplates that the preassembled body modules included in either the first body or the second body may further include a floor portion that is operatively connected to the body frame portion and at least partially forms a floor. The preassembled body modules may further include a seating apparatus operatively connected to the floor portion.

The invention contemplates that the different configuration of the preassembled body module in the first body may define a different body style than the body modules used in the second body. For example, the first body may be a passenger car body while the second body may be a pickup truck body. Additionally, it is within the scope of the invention that the preassembled body modules used in the first body may be of a different material, which may be plastic, than the body modules used in the second body, which may be steel.

The method 263 may further include maintaining an inventory 273 of a plurality of different preassembled body modules. If such an inventory is maintained, the method may further include selecting a preassembled body module 275 from the inventory. The invention contemplates that maintaining an inventory 273 and selecting a preassembled body module 275 from the inventory are completed before mounting a first body 269 or before mounting a second body 271, depending upon whether the first body or the second body included the body module selected from the inventory.

While the best modes for carrying out the invention have been described in detail, those familiar with the art to which this invention relates will recognize various alternative designs and embodiments for practicing the scope of the invention within the scope of the appended claims.

1. A method of assembling a vehicle, the method comprising:
providing a preassembled chassis having a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel; and
mounting a vehicle body at an upper face of the preassembled chassis, the body having at least one seating apparatus adapted to be operably connectable to the chassis, a body frame adapted to be operably connectable to the chassis, and a plurality of body panels adapted to be operably connectable to the body frame.

2. The method of claim 1, wherein the body includes a floor adapted to be operably connectable to the chassis.

3. The method of claim 2, wherein the body is a preassembled body module, having the body frame and the at least one seating apparatus operatively connected to the floor, and the body panels operatively connected to the body frame.

4. The method of claim 2, wherein the body includes at least two preassembled body modules, each of said at least two body modules having a floor portion at least partially forming the floor, a body frame portion at least partially forming the body frame and operatively connected to the floor portion, and at least one body panel operatively connected to the body frame portion; wherein at least one of said at least two preassembled body modules includes said at least one seating apparatus; and wherein said at least one seating apparatus is operatively connected to the floor portion.

5. The method of claim 3, wherein the body module is preassembled in different configurations, and further comprising:
maintaining an inventory of a plurality of preassembled body module configurations; and
selecting a preassembled body module from the inventory for mounting the desired configuration.

6. The method of claim 4, wherein said at least two body modules are preassembled in different configurations, and further comprising:
maintaining an inventory of a plurality of preassembled body module configurations; and
selecting at least one of said at least two preassembled body modules from the inventory for mounting the desired configuration.

7. The method of claim 1, wherein mounting the body at an upper face of the preassembled chassis includes
operatively connecting at least one seating apparatus to the chassis;
operatively connecting the body frame to the chassis; and
operatively connecting the plurality of body panels to the body frame.

8. The method of claim 2, wherein mounting the body at an upper face of the preassembled chassis includes
mounting the floor to the preassembled chassis;
operatively connecting at least one seating apparatus to the floor;
operatively connecting the body frame to the chassis; and
operatively connecting the plurality of body panels to the body frame.

9. The method of claim 1, wherein the body includes at least one preassembled body module and mounting the body at an upper face of the preassembled chassis includes
operatively connecting said at least one seating apparatus to the chassis; and
operatively connecting said at least one preassembled body module to the chassis, said at least one preassembled body module having a body frame portion at least partially forming the body frame and at least one body panel operatively connected to the body frame portion.

10. The method of claim 2, wherein the body includes at least one preassembled body module and mounting the body at an upper face of the preassembled chassis includes
mounting the floor to the preassembled chassis;
operatively connecting said at least one seating apparatus to the floor; and
operatively connecting said at least one preassembled body module to the chassis, said at least one preassembled body module having a body frame portion at least partially forming the body frame and at least one body panel operatively connected to the body frame portion.

11. The method of claim 1, wherein the body includes at least two preassembled body modules and mounting the body to the preassembled chassis includes
operatively connecting said at least one seating apparatus to the chassis; and
operatively connecting said at least two preassembled body modules to the chassis, said at least two preassembled body modules each having a body frame portion at least partially forming the body frame and at least one of the body panels operatively connected to the body frame portion.

12. The method of claim 2, wherein the body includes at least two preassembled body modules and mounting the body to the preassembled chassis includes
mounting the floor to the preassembled chassis;
operatively connecting said at least one seating apparatus to the floor; and
operatively connecting said at least two preassembled body modules to the chassis, said at least two preassembled body modules each having a body frame portion at least partially forming the body frame and at least one of the body panels operatively connected to the body frame portion.

13. The method of claim 2, wherein the floor has floor portions, the body includes at least one preassembled body module and mounting the body to the preassembled chassis includes
operatively connecting at least two of the floor portions to the preassembled chassis, said at least two floor portions at least partially forming the floor;
operatively connecting at least one seating apparatus to at least one of the two floor portions; and
operatively connecting said at least one preassembled body module to the chassis, said at least one preassembled body module having a body frame portion at least partially forming the body frame, and at least one body panel operatively connected to the body frame portion.

14. The method of claim 1, further comprising:
positioning the body above the preassembled chassis prior to mounting the body at the upper face of the chassis; and
connecting the body to the upper face of the chassis.

15. The method of claim 14, wherein positioning the body is accomplished by automated means.

16. The method of claim 15, wherein the automated means include a conveyor system.

17. The method of claim 15, wherein the automated means include an hydraulic lift.

18. The method of claim 1, further comprising positioning the preassembled chassis below the body prior to mounting the body at the upper face of the chassis.

19. The method of claim 18, wherein positioning the preassembled chassis is accomplished by automated means.

20. The method of claim 19, wherein the automated means include a conveyor system.

21. The method of claim 19, wherein the automated means include an hydraulic lift.

22. The method of claim 1, wherein the chassis further includes a suspension system that is responsive to non-mechanical control signals.

23. The method of claim 1, wherein at least a portion of the body is manufactured using quick plastic forming.

24. The method of claim 1, wherein at least a portion of the body is manufactured using super plastic forming.

25. The method of claim 1, wherein at least a portion of the body is manufactured using hydroforming.

26. The method of claim 1, wherein the body is operatively connected to the chassis when the body is mounted at the upper face of the preassembled chassis so that at least one of the systems will respond to the respective non-mechanical control signals.

27. The method of claim 1, wherein mounting the body at the upper face of the preassembled chassis further includes moving the body toward the chassis from a direction above the upper face of the chassis.

28. The method of claim 1, wherein mounting the body is facilitated by relative movement between the body and the chassis.

29. The method of claim 28, wherein the relative movement is body toward chassis.

30. The method of claim 29, wherein the movement of the body is down.

31. The method of claim 28, wherein the relative movement is chassis toward body.

32. The method of claim 31, wherein the movement of chassis is up.

33. A method of assembling vehicles, the method comprising:
providing a first preassembled chassis;
providing a second preassembled chassis, wherein the first and second preassembled chassis are substantially identical and each has a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel;
mounting a first body at the upper face of the first preassembled chassis;
mounting a second body at the upper face of the second preassembled chassis, wherein the bodies each have at least two preassembled body modules, the preassembled body modules including a body frame portion at least partially forming a body frame, and at least one body panel operatively connected to the body frame portion; and
wherein the configuration of at least one of the preassembled body modules of the first body is sufficiently different than at least one of the preassembled body modules of the second body, such that the first body is different from the second body.

34. The method of claim 33, wherein the configuration of said at least one of the preassembled body modules of the first body defines a different body style than the configuration of said at least one of the preassembled body modules of the second body.

35. The method of claim 33, wherein said at least one of the preassembled body modules of the first body is of a different material than at least one of the preassembled body modules of the second body.

36. The method of claim 33, wherein at least one of the preassembled body modules of the first body further includes a floor portion operatively connected to the body frame portion and at least partially forming a floor.

37. The method of claim 36, wherein at least one of the preassembled body modules of the first body further includes a seating apparatus operatively connected to the floor portion.

38. The method of claim 33, further comprising:
maintaining an inventory of a plurality of preassembled body module configurations; and
selecting at least one of the preassembled body modules from the inventory for mounting the desired configuration at the upper face of one of the preassembled chassis.

39. A method of assembling vehicles, the method comprising:
providing a preassembled chassis having a structural frame, at least three wheels operable with respect to the frame, an energy conversion system responsive to non-mechanical control signals and operatively connected to the structural frame and to at least one wheel, a steering system responsive to non-mechanical control signals and operatively connected to the structural frame and to at least one wheel, and a braking system responsive to non-mechanical control signals and operatively connected to the structural frame and to at least one wheel;
mounting a body at an upper face of the preassembled chassis, the body having a floor, at least one seating apparatus adapted to be operably connectable to the floor, a body frame adapted to be operably connectable to the chassis, and a plurality of body panels adapted to be operably connectable to the body frame, wherein at least a portion of the body is formed through a quick plastic forming method and the body includes at least two preassembled body modules, each of said at least two body modules having a floor portion at least partially forming the floor, a body frame portion at least partially forming the body frame, and at least one body panel operatively connected to the body frame portion, wherein at least one of the at least two preassembled body modules includes the at least one seating apparatus operatively connected to the floor portion;
positioning the body above the preassembled chassis prior to mounting the body at the upper face of the chassis; and
connecting the body to the upper face of the chassis.
